(19) United States
(12) Patent Application Publication
(10) Pub. No.: US 2025/0257213 A1
(43) Pub. Date: Aug. 14, 2025

(54) Thermally Conductive Flame-Proof Polycarbonate Compositions Having a High Comparative Tracking Index

(71) Applicant: Covestro Deutschland AG, Leverkusen (DE)

(72) Inventors: Tim Hungerland, Köln (DE); Marius Nolte, Köln (DE); Matthias Knaupp, Langenfeld (DE)

(21) Appl. No.: 18/856,407

(22) PCT Filed: Apr. 6, 2023
(86) PCT No.: PCT/EP2023/059150

§ 371 Date: Oct. 11, 2024

(30) Foreign Application Priority Data
Apr. 14, 2022 (EP) 22168335.2

(51) Int. Cl. C08L 69/00; C08G 64/14; C08K 3/22; C08K 3/34; C08K 5/5399

(52) U.S. Cl. CPC C08L 69/005; C08G 64/14; C08K 3/34; C08K 5/5399; C08K 2003/2241; C08L 2201/02; C08L 2203/206; C08L 2205/025; C08L 2205/035

(57) ABSTRACT

Described are thermally conductive flame-proof compositions which have a high comparative tracking index and contain at least 44.5 wt. % aromatic polycarbonate in which bisphenol TMC is used as a monomer unit, 30 to 40 wt. % talc, 6 to 14 wt. % phosphorus-containing flame retardant, 0.3 to 2.0 wt. % fluorine-containing anti-drip agent, and 1 to 3 wt. % anhydride-modified α-olefin polymer. Said compositions have a high comparative tracking index, thus allowing distances between electrical conductors in electronic and electrical components to be kept shorter than in the past.

### CROSS-REFERENCE TO RELATED APPLICATIONS

This application is the United States national phase of International Patent Application No. PCT/EP2023/059150 filed Apr. 6, 2023, and claims priority to European Patent Application No. 22168335.2 filed Apr. 14, 2022, the disclosures of which are hereby incorporated by reference in their entireties.

### BACKGROUND

### Technical Field

The invention relates to thermally conductive, flame-retardant thermoplastic compositions based on polycarbonate having high comparative tracking index.

### Description of Related Art

On account of its high impact strength, high heat distortion resistance and a certain inherent flame retardancy, polycarbonate offers many advantages over other thermoplastic polymers. Due to this unique profile of properties, polycarbonate compositions are suitable in principle for a variety of different applications, for example in the field of electrical and electronic components. In particular, good insulation properties and high flame retardancy are essential safety-relevant basic requirements for materials used in this area.

In applications in which the plastic is in direct contact with the electrical conductor paths, a high resistance to tracking currents under voltage load is a prerequisite, in order for there not to be any short circuits within the component and hence a fire. The comparative tracking index (CTI) describes in general the resistance of a plastics material to environmental influences. The CTI value is a measure of the inclination of a plastic, under environmental influences, such as moisture and soiling, to form under voltage electrically conductive paths on the surface and promote resulting electrical tracking currents. The higher the tracking current resistance or the comparative tracking index (CTI value) of a material, the better suited it is for use in high-voltage applications, for example in modern-day electromobility applications. Another advantage of materials having a high CTI value is the possibility of placing electrical conductor paths in an electronic component closer together without risking a short circuit, which in turn enables the reduction of component dimensions and thus more compact designs and weight savings.

In contrast to other thermoplastic polymers such as polystyrene, polyester, etc., polycarbonate itself has a very low comparative tracking index with moderate flame retardancy. Due to the high proportion of aromatic structures, polycarbonate has a rather high tendency to carbonize. The CTI of pure polycarbonate is about 250 V or even lower (F. Acquasanta et al., Polymer Degradation and Stability, 96 (2011), 2098-2103). However, for numerous applications in the electronics/electricals (EE) sector, for example in the electromobility sector, safety grounds require a higher CTI, for example of at least 375 V, preferably of at least 400 V (corresponding to insulating material group PLC 0 according to EN 50124), of the materials used. Polycarbonate has therefore to date not been considered as a material for a multitude of applications that specifically require a high comparative tracking index of the material.

For applications which require a high comparative tracking index of the material, the materials must at the same time also have a high flame retardancy, i.e. a V0 classification according to UL 94V, in particular even at thin wall thicknesses.

Although pure polycarbonate typically already has a certain intrinsic flame retardancy (V2 classification according to UL 94 V), this is not sufficient for most applications in the EE sector. In order to achieve the required V0 classification according to UL94V, the addition of suitable flame retardants is required. Typically employed for polycarbonate are halogenated sulfonates (e.g. Rimar salt (potassium perfluorobutanesulfonate, C4 salt) or KSS salt (potassium diphenylsulfone 3-sulfonate)) or also organic phosphates (e.g. bisphenol A bis(diphenyl phosphate) (BDP), resorcinol bis(diphenyl phosphate) (RDP)) or phosphazenes. The flame retardancy of polycarbonate can in principle be adjusted very well with the addition of appropriate flame retardant additives. The mechanism of action of these flame retardants is however based on the formation of a solid, carbonized surface layer that interrupts the oxygen supply and thus inhibits the combustion process.

However, the effect forming the basis for a good comparative tracking index is in turn, inter alia, a low tendency to form conductive paths on the surface. This is in direct contrast to the mechanism of action, the “charring”, of surface-active flame retardants and thus poses a particular challenge in achieving a high comparative tracking index and good flame retardancy in a polycarbonate material.

Materials that have a high comparative tracking index are especially required in the field of electronic components or current-carrying components. Any current flow is associated with the generation of heat, which increases with increasing power. In order to prevent technical failure and to thus ensure the longevity of such components, it is necessary for the heat produced to be sufficiently dissipated. It would be desirable if it were possible to provide a polycarbonate material that has a relatively high comparative tracking index and flame retardancy and at the same time can also contribute to the dissipation of heat.

Thermally conductive polycarbonate material is known in principle from the prior art. For instance, WO 2018/037037 A1 describes corresponding compositions that have improved thermal conductivity due to the use of talc. The basic polymer degradation caused by the talc is largely suppressed by the addition of maleic anhydride-modified olefin wax, resulting in a material with advantageous mechanical properties. Such a material however does not feature good flame retardancy and the comparative tracking index is not significantly increased in comparison with pure polycarbonate either.

### SUMMARY

The object was therefore that of providing thermally conductive polycarbonate-based compositions that achieve a UL94 V0 classification at 2 mm, preferably at 1.5 mm, and also have a high CTI of at least 375 V, preferably of at least 400 V, preferably determined according to the rapid test method based on IEC 60112:2009. The thermal conductivity (in-plane) should preferably be at least 0.9 W/(mK), determined according to ASTM E 1461-13. Due to the area of application and the heat development in EE components, the compositions should preferably also have a good heat distortion resistance, in particular a Vicat softening temperature, determined according to ISO 306:2014-3, VST method B, of at least 107° C., preferably of at least 108° C., particularly preferably of at least 120° C.

Surprisingly, it has been found that this object of providing compositions having such a complex profile of properties is achieved by the combination of talc and aromatic polycarbonate with phosphorus-containing flame retardant, with anti-drip agent and the use of specific monomer unit-containing polycarbonate, each in selected amount ranges.

The invention thus provides a thermoplastic composition, containing
A) at least 44.5% by weight of aromatic polycarbonate, wherein the aromatic polycarbonate comprises one or more monomer units of formula (1a)

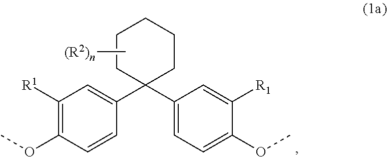

in which
   R¹ is hydrogen or a C₁—to C₄-alkyl radical,
   R² is a C₁—to C₄-alkyl radical,
   n is 0, 1, 2 or 3,
in a proportion of 30%-65% by weight, based on the total weight of the aromatic polycarbonate,
B) 30% to 40% by weight of talc,
C) 6% to 14% by weight of phosphorus-containing flame retardant, wherein the quotient of
the amount of component C, based on the overall composition, and
the amount of component A, based on the overall composition,
multiplied by 100,
is >10.0,
D) 0.3% to 2.0% by weight of fluorine-containing anti-drip agent,
E) 1% to 3% by weight of anhydride-modified α-olefin polymer,
wherein, if the talc content is <35.0% by weight, the proportion of monomer units of formula (1a), based on the total weight of the aromatic polycarbonate, is at least 35% by weight and
wherein, if the talc content is >37% by weight, phosphazene is present as phosphorus-containing flame retardant and the phosphazene content is >10.0% by weight.

In addition to components A, B, C, D and E, the composition according to the invention may contain further components, for instance further additives in the form of component F. The composition may also contain one or more further thermoplastics not covered by any of components A to F as blend partners (component G). In the context of the present invention—unless explicitly stated otherwise—the stated % by weight values for components A, B, C, D, E and optionally F and also optionally blend partners are each based on the total weight of the composition. It will be appreciated that all of the components present in a composition according to the invention sum to 100% by weight. Where a numerical range has its upper limit indicated by “to X”, this includes the numerical value specified and its upward rounding range.

Thermoplastic polymers that are different from components A and E and are suitable as blend partner include for example polystyrene, styrene copolymers, aromatic polyesters such as polyethylene terephthalate (PET) or polybutylene terephthalate (PBT), PET-cyclohexanedimethanol copolymer (PETG), polyethylene naphthalate (PEN), PMMA and PMMA copolymers, and copolymers with styrene such as transparent polystyrene-acrylonitrile (PSAN) or else also thermoplastic polyurethanes. These blend partners are preferably used in concentrations of 0.5% by weight to 10% by weight.

However, it is very particularly preferable when the above-described compositions do not contain any further components, and instead the amounts of components A, B, C, D, E and optionally F, in particular in the preferred embodiments described, add up to 100% by weight, i.e. the compositions according to the invention consist of components A, B, C, D, E, optionally F.

It will be appreciated that the components used may contain typical impurities arising for example from their production processes. It is preferable to use the purest possible components. It will further be appreciated that these impurities may also be present in the event of an exhaustive formulation of the composition.

### DETAILED DESCRIPTION

The compositions according to the invention exhibit no significant tracking current (>0.5 A over 2 s) when at least 50 drops of a 0.1% ammonium chloride solution are applied at 375 V, further preferably at 400 V, particularly preferably at 500 V, with the test preferably being carried out according to the rapid test method based on IEC 60112:2009 and described in the description part. Preferably, the compositions according to the invention have a flame retardancy V0 according to UL 94 V in thicknesses of the test specimens of 3 mm, further preferably at thicknesses of the test specimens of 2 mm, further preferably still also of at least V1, very particularly preferably of V0, at 1.5 mm, in each case after conditioning the test specimens for 7 days at 50% relative humidity and 70° C. ambient temperature. In addition to the high CTI and the good flame retardancy, the compositions preferably also have a good heat distortion resistance, which is manifested in a Vicat softening temperature, determined according to ISO 306:2014-3, VST method B, of at least 107° C., preferably of at least 108° C., particularly preferably of at least 120° C.

The individual constituents of the compositions according to the invention are more particularly elucidated hereinbelow:

### Component A

Component A of the compositions according to the invention are aromatic polycarbonates.

Aromatic polycarbonates in the context of the present invention include not only homopolycarbonates but also copolycarbonates and/or polyestercarbonates; the polycarbonates may be linear or branched in a known manner. Mixtures of polycarbonates may also be used according to the invention.

The thermoplastic polycarbonates, including the thermoplastic aromatic polyestercarbonates, preferably have weight-average molecular weights M_{w} of 15 000 g/mol to 40 000 g/mol, further preferably to 34 000 g/mol, particularly preferably of 17 000 g/mol to 33 000 g/mol, in particular of 19 000 g/mol to 32 000 g/mol, determined by gel permeation chromatography, calibrated against bisphenol A polycarbonate standards using dichloromethane as eluent, calibration with linear polycarbonates (formed from bisphenol A and phosgene) of known molar mass distribution from PSS Polymer Standards Service GmbH, Germany, and calibration by method 2301-0257502-09D (2009 German-language edition) from Currenta GmbH & C0. OHG, Leverkusen. The eluent is dichloromethane. Column combination of crosslinked styrene-divinylbenzene resins. Diameter of the analytical columns: 7.5 mm; length: 300 mm. Particle sizes of the column material: 3 μm to 20 μm. Concentration of the solutions: 0.2% by weight. Flow rate: 1.0 ml/min, temperature of the solutions: 30° C. Use of UV and/or RI detection.

The melt volume flow rate MVR of the aromatic polycarbonate used, determined according to ISO 1133:2012-03, at a test temperature of 300° C. and with 1.2 kg load, is preferably 5 to 35 cm³/(10 min), further preferably 6 cm³/(10 min) to 25 cm³/(10 min), further preferably still 6 to 21 cm³/(10 min).

A portion of up to 80 mol %, preferably of 20 mol % to 50 mol %, of the carbonate groups in the polycarbonates used according to the invention may be replaced by aromatic dicarboxylic ester groups. Polycarbonates of this type that have not only acid radicals derived from carbonic acid but also acid radicals derived from aromatic dicarboxylic acids incorporated into the molecular chain are referred to as aromatic polyestercarbonates. For the purposes of the present invention, they are subsumed within the umbrella term “thermoplastic aromatic polycarbonates”.

Details of the preparation of polycarbonates have been set out in many patent specifications over the past 40 years or so. Reference may be made here by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718 and finally to U. Grigo, K. Kirchner and P. R. Müller “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117 to 299.

Aromatic polycarbonates are prepared, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Likewise possible is preparation via a melt polymerization process, by reacting dihydroxyaryl compounds with, for example, diphenyl carbonate.

For the preparation of the polyestercarbonates, a portion of the carbonic acid derivatives is replaced by aromatic dicarboxylic acids or derivatives of the dicarboxylic acids, and specifically with aromatic dicarboxylic ester structural units according to the carbonate structural units to be replaced in the aromatic polycarbonates.

Dihydroxyaryl compounds suitable for the preparation of polycarbonates are those of formula (1)

HO—Z—OH (1),
in which
Z is an aromatic radical which has 6 to 30 carbon atoms, may contain one or more aromatic rings, may be substituted and may contain aliphatic or cycloaliphatic radicals or alkylaryls or heteroatoms as bridging elements.

It is preferable for Z in formula (1) to be a radical of formula (2)

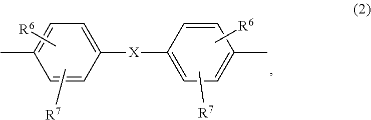

in which
R⁶ and R⁷ are independently H, C₁—to C₁₈-alkyl, C₁—to C₁₈-alkoxy, halogen such as Cl or Br or in each case optionally substituted aryl or aralkyl, preferably H or C₁—to C₁₂-alkyl, particularly preferably H or C₁—to C₈-alkyl and very particularly preferably H or methyl, and
X is a single bond, —SO₂—, —CO—, —O—, —S—, C₁—to Co-alkylene, C₂—to C₅-alkylidene or C₅- to C₆-cycloalkylidene which may be substituted by C₁—to C₆-alkyl, preferably methyl or ethyl, or else C₆—to C₁₂-arylene which may optionally be fused to further aromatic rings containing heteroatoms.
X is preferably a single bond, C₁—to C₅-alkylene, C₂—to C₅-alkylidene, C₅—to Co-cycloalkylidene, —O—, —SO—, —CO—, —S—, —SO₂—
or a radical of formula (3)

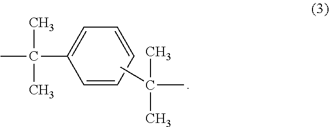

Examples of dihydroxyaryl compounds are: dihydroxybenzenes, dihydroxydiphenyls, bis(hydroxyphenyl)alkanes, bis(hydroxyphenyl)cycloalkanes, bis(hydroxyphenyl) aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and the ring-alkylated and ring-halogenated compounds thereof.

Dihydroxyaryl compounds suitable for the preparation of polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein, and the ring-alkylated, ring-arylated and ring-halogenated compounds thereof.

Preferred dihydroxyaryl compounds are 4,4′-dihydroxydiphenyl, 2,2-bis(4-hydroxyphenyl) propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl) propane, dimethylbisphenol A, bis(3,5-dimethyl-4-hydroxyphenyl) methane, 2,2-bis(3,5-dimethyl-4-hydroxyphenyl) propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the dihydroxyaryl compounds (I) to (III)

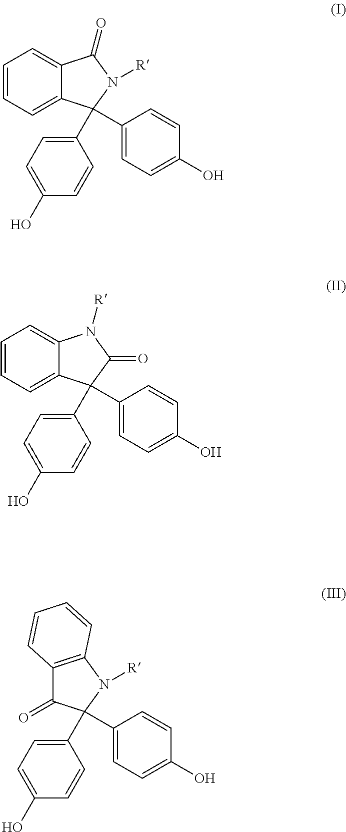

in which each R′ is a C₁—to C₄-alkyl radical, aralkyl radical or aryl radical, preferably a methyl radical or phenyl radical, very particularly preferably a methyl radical.

Particularly preferred dihydroxyaryl compounds are 2,2-bis(4-hydroxyphenyl) propane (bisphenol A), 2,2-bis(3,5-dimethyl-4-hydroxyphenyl) propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (I), (II) and (III).

These and other suitable dihydroxyaryl compounds are described by way of example in US 3 028 635 A, US 2 999 835 A, US 3 148 172 A, US 2 991 273 A, US 3 271 367 A, US 4 982 014 A and US 2 999 846 A, in DE 1 570 703 A, DE 2063 050 A, DE 2 036 052 A, DE 2 211 956 A and DE 3 832 396 A, in FR 1 561 518 A, in the monograph “H. Schnell, Chemistry and Physics of Polycarbonates, Interscience Publishers, New York 1964”, and in JP 62039/1986 A, JP 62040/1986 A and JP 105550/1986 A.

In the case of the homopolycarbonates, only one dihydroxyaryl compound is used; in the case of the copolycarbonates, two or more dihydroxyaryl compounds are used.

Examples of suitable carbonic acid derivatives include phosgene or diphenyl carbonate.

Suitable chain terminators that may be used in the preparation of the polycarbonates are monophenols. Examples of suitable monophenols include phenol itself, alkylphenols such as cresols, p-tert-butylphenol, cumylphenol, and mixtures thereof.

Preferred chain terminators are the phenols which have substitution by one or more linear or branched, preferably unsubstituted, C₁—to C₃₀-alkyl radicals, or by tert-butyl. Particularly preferred chain terminators are phenol, cumylphenol and/or p-tert-butylphenol.

The amount of chain terminator to be used is preferably 0.1 to 5 mol %, based on moles of dihydroxyaryl compounds used in each case. The chain terminators may be added before, during or after the reaction with a carbonic acid derivative.

Suitable branching agents are the trifunctional or more than trifunctional compounds known in polycarbonate chemistry, in particular those having three or more than three phenolic OH groups.

Examples of suitable branching agents include 1,3,5-tri (4-hydroxyphenyl)benzene, 1,1,1-tri (4-hydroxyphenyl) ethane, tri (4-hydroxyphenyl)phenylmethane, 2,4-bis(4-hydroxyphenylisopropyl) phenol, 2,6-bis(2-hydroxy-5′-methylbenzyl)-4-methylphenol, 2-(4-hydroxyphenyl)-2-(2,4-dihydroxyphenyl) propane, tetra(4-hydroxyphenyl) methane, tetra(4-(4-hydroxyphenylisopropyl) phenoxy) methane and 1,4-bis((4′,4″-dihydroxytriphenyl)methyl)benzene and 3,3-bis(3-methyl-4-hydroxyphenyl)-2-oxo-2,3-dihydroindole.

The amount of any branching agents to be used is preferably 0.05 mol % to 2.00 mol %, based on moles of dihydroxyaryl compounds used in each case.

The branching agents can either form an initial charge with the dihydroxyaryl compounds and the chain terminators in the aqueous alkaline phase or can be added, dissolved in an organic solvent, before the phosgenation. In the case of the transesterification method, the branching agents are used together with the dihydroxyaryl compounds.

Particularly preferred polycarbonates are the homopolycarbonate based on bisphenol A, the homopolycarbonate based on 1,1-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane or the two monomers bisphenol A and 4,4′-dihydroxydiphenyl, and homo- or copolycarbonates derived from the dihydroxyaryl compounds of formulae (I), (II) and/or (III)

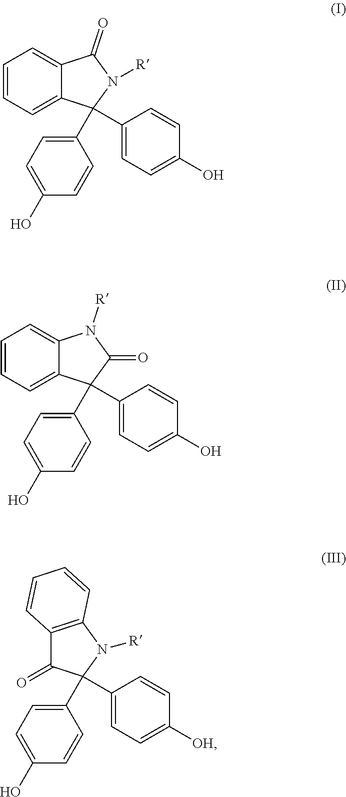

in which each R′ is C₁—to C₄-alkyl, aralkyl or aryl, preferably methyl or phenyl, very particularly preferably methyl,
   especially with bisphenol A. Very particularly preferably, the aromatic polycarbonate comprises a bisphenol A-based homopolycarbonate and a copolycarbonate based on the two monomers bisphenol A and 1,1-bis(4-hydroxyphenyl)-3,3,5-trimethylcyclohexane. Exceptionally preferably, the aromatic polycarbonate is a mixture of bisphenol A-based homopolycarbonate and copolycarbonate based on the two monomers bisphenol A and 1,1-bis(4-hydroxyphenyl)-3,3,5-trimethylcyclohexane.

The total proportion of the monomer units based on formulae (I), (II), (III), 4,4′-dihydroxydiphenyl and/or bisphenol TMC in the copolycarbonate is preferably 0.1-88 mol %, particularly preferably 1-86 mol %, very particularly preferably 5-84 mol % and in particular 10-82 mol % (based on the sum total of the moles of dihydroxyaryl compounds used).

The relative solution viscosity of the copolycarbonates, determined according to ISO 1628-4:1999, is preferably in the range of 1.15-1.35.

The dihydroxyaryl compounds used, like all the other chemicals and auxiliaries added to the synthesis, may be contaminated with the impurities originating from their own synthesis, handling and storage. It is however desirable to use raw materials of the highest possible purity.

Examples of aromatic dicarboxylic acids that are suitable for the preparation of the polyestercarbonates include orthophthalic acid, terephthalic acid, isophthalic acid, tert-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyl ether dicarboxylic acid, 4,4′-diphenylsulfonedicarboxylic acid, 2,2-bis(4-carboxyphenyl) propane, trimethyl-3-phenylindane-4,5′-dicarboxylic acid.

Among the aromatic dicarboxylic acids, particular preference is given to using terephthalic acid and/or isophthalic acid.

Derivatives of dicarboxylic acids are dicarbonyl dihalides and dialkyl dicarboxylates, especially dicarbonyl dichlorides and dimethyl dicarboxylates.

Replacement of the carbonate groups by the aromatic dicarboxylic ester groups is substantially stoichiometric, and also quantitative, and the molar ratio of the reactants is therefore also maintained in the final polyestercarbonate. The aromatic dicarboxylic ester groups may be incorporated either randomly or in blocks.

The compositions according to the invention contain at least 44.5% by weight, preferably at least 50% by weight, of aromatic polycarbonate, and are thus based on aromatic polycarbonate.

According to the invention, the aromatic polycarbonate of the compositions contains 30% to 65% by weight, preferably to 60% by weight, particularly preferably 40% to 55% by weight, very particularly preferably 40% to 50% by weight, based on the total weight of aromatic polycarbonate, of one or more monomer units of formula (1a)

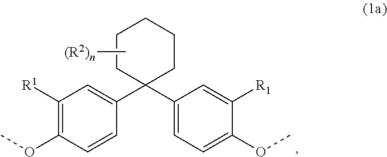

in which
   R¹ is hydrogen or a C₁—to C₄-alkyl radical, preferably hydrogen,
   R² is a C₁—to C₄-alkyl radical, preferably a methyl radical,
   n is 0, 1, 2 or 3, preferably 3.

A corresponding copolycarbonate which is preferably used according to the invention is available for example under the “APEC®” name from Covestro Deutschland AG.

The aforementioned content of corresponding monomer units, for example of bisphenol TMC, in the aromatic polycarbonate of the composition is achieved by mixing a homopolycarbonate composed of such monomer units, preferably a bisphenol TMC homopolycarbonate, with one or more other (co) polycarbonates or exclusive use or copolycarbonate containing corresponding units, preferably containing bisphenol TMC units, or the mixing of a copolycarbonate containing corresponding monomer units, preferably containing bisphenol TMC units, with one or more homo- or copolycarbonates. According to the invention, the aromatic polycarbonate of the compositions is particularly preferably copolycarbonate containing bisphenol TMC units, or a mixture of copolycarbonate containing bisphenol TMC units with bisphenol A homopolycarbonate. “Polycarbonate containing bisphenol TMC units” is understood according to the invention to mean a polycarbonate that contains bisphenol TMC as incorporated monomer unit.

Bisphenol TMC, 1,1-bis(4-hydroxyphenyl)-3,3,5-trimethylcyclohexane, (formula (1a′)) and its use in homopolycarbonates are known from the literature (DE 3918406 A1)

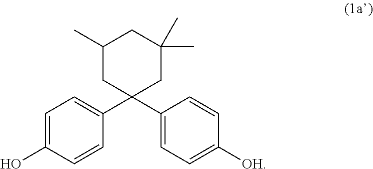 [SMILES: CC1CC(C)(C)CC(c2ccc(O)cc2)(c2ccc(O)cc2)C1]

The total proportion of the monomer units of formulas (1a′) in the copolycarbonate is preferably 0.1-88 mol %, particularly preferably 1-86 mol %, very particularly preferably 5-84 mol % and in particular 10-82 mol % (based on the sum total of the moles of diphenols used).

In the case of 30% by weight or more of bisphenol TMC in the copolycarbonate, the Vicat temperature (VST/B 120; ISO 306:2013) of the copolycarbonate is more than 175° C. Bisphenol A is preferably used as comonomer. Particularly preferably, the copolycarbonate is formed from the monomers bisphenol TMC and bisphenol A.

The copolycarbonates may be in the form of block copolycarbonate and random copolycarbonate. Random copolycarbonates are particularly preferred.

### Component B

Talc in the context of the present invention is preferably a tale of essentially the same chemical composition, particle diameter, porosity and/or BET surface area, or a talc mixture.

Talc is generally a phyllosilicate. It can be described as magnesium silicate hydrate having the general chemical composition Mg₃ [Si₄O₁₀(OH)₂]. However, different types of talc contain different impurities, and so there may be deviations from this general composition.

The talc used or the talc mixture for the preparation of the composition according to the invention may be sized or unsized. The talc is preferably unsized. In the context of the present invention, a size is considered to be a controlled (chemi- or physisorbed) enrichment of molecules at the surface. Unsized talc is thus non-surface-treated talc, meaning that, after the talc particles having the desired particle diameter have been recovered and optionally subjected to compaction, the talc preferably has not been subjected to any further process step that alters the surface of the talc in a controlled manner by chemisorption and/or physisorption. However, this does not rule out the unintentional arrival of impurities, dust or similar particles on parts of the surface during the further handling of the talc, provided that the surface of the talc does not lose its properties to any significant degree, especially in relation to the pH.

The talc preferably has a pH of 8 to 10, particularly preferably 8.5 to 9.8, very particularly preferably 9.0 to 9.7, where the pH is determined according to EN ISO 787-9:1995. It should be noted that EN ISO 787-9:1995 also mentions the option of adding ethanol or other organic solvents to improve the dispersion of the solid to be analyzed. Preference is given according to the invention to using only distilled water for the determination of the pH according to EN ISO 787-9:1995.

Component B, the talc, preferably has a content of iron (II) oxide and/or iron (III) oxide of 0.2% to 2.5% by weight, particularly preferably 0.3% to 2.3% by weight, very particularly preferably from 0.3% to 2.0% by weight. This content is preferably measured by x-ray fluorescence or atomic absorption spectroscopy. The content of iron oxide in the talc has an influence on the degree of degradation of the polycarbonate. It is advantageous to use talc with the specified iron oxide content.

Likewise preferably, component B has a content of aluminum oxide of 0.01% to 0.5% by weight, particularly preferably of 0.05% to 0.48% by weight, very particularly preferably of 0.15% to 0.45% by weight.

Component B preferably has an average particle diameter D50 of 0.01 to 10 μm, particularly preferably 0.25 to 10.00 μm, further preferably 0.5 to 10.00 μm, where the particle diameter D50 is determined by sedimentation analysis. The average D50 value is understood by those skilled in the art to mean an average particle diameter at which 50% of the particles are smaller than the defined value. The particle diameter D50 is preferably determined according to ISO13317-3:2001.

Component B preferably has a BET surface area of 7.5 to 20.0 m²/g, particularly preferably of 9.0 to 15.0 m²/g, very particularly preferably 9.5 to 14.0 m²/g. The determination of the surface area according to Brunauer, Emmett and Teller by means of gas adsorption is known per se to those skilled in the art. The BET surface area is preferably determined according to ISO 4652:2012. This preferred BET surface area is particularly preferably linked to the above-described average particle diameter D50 of the talc. It has been found that, in the case of such a combination, component B used according to the invention is optimally matched to component C used according to the invention. By way of the specific acid number and molar mass of component E, the degradation of the polycarbonate caused by component B can be minimized.

Particularly preferably, the talc has a talc content of >96% by weight, particularly preferably >97% by weight, very particularly preferably >98% by weight.

It is likewise preferable that the talc has an ignition loss at 1050° C. of 5.0% to 7.0% by weight, particularly preferably of 5.2% to 6.5% by weight and very particularly preferably of 5.3% to 6.2% by weight. The ignition loss is preferably determined by means of DIN51081:2002.

The talc or the talc mixture according to component B is preferably in compacted form. If it is a talc mixture, the abovementioned figures are each based on the talc mixture, i.e. component B in its entirety.

The compositions according to the invention have a talc content of 30% to 40% by weight, preferably of 30% to 35% by weight, based on the overall composition.

### Component C

Component C of the compositions according to the invention is phosphorus-containing flame retardants. It may be a single phosphorus-containing flame retardant, but it may also be a mixture of various phosphorus-containing flame retardants.

Preferred phosphorus-containing flame retardants are cyclic phosphazenes, phosphorus compounds of formula (10), and mixtures thereof:

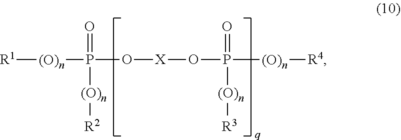

in which
R¹, R², R³ and R⁴ are independently a C₁—to C₈-alkyl radical, in each case optionally halogenated and in each case branched or unbranched, and/or C₅—to C₆-cycloalkyl radical, C₆—to C₂₀-aryl radical or C₇—to C₁₂-aralkyl radical, in each case optionally substituted by branched or unbranched alkyl, and/or halogen, preferably chlorine and/or bromine,
n is independently 0 or 1,
q is a value from 0 to 30 and
X is a mono- or polycyclic aromatic radical having 6 to 30 carbon atoms or a linear or branched aliphatic radical having 2 to 30 carbon atoms, each of which may be substituted or unsubstituted, and bridged or unbridged.

Preferably, R¹, R², R³ and R⁴ are independently branched or unbranched C₁—to C₄-alkyl, phenyl, naphthyl or C₁—to C₄-alkyl-substituted phenyl. In the case of aromatic R¹, R², R³ and/or R⁴ groups, these may in turn be substituted by halogen and/or alkyl groups, preferably chlorine, bromine and/or C₁—to C₄-alkyl, branched or unbranched. Particularly preferred aryl radicals are cresyl, phenyl, xylenyl, propylphenyl or butylphenyl, and also the corresponding brominated and chlorinated derivatives thereof.

X in formula (10) is preferably derived from dihydroxyaryl compounds.

X in formula (10) is particularly preferably

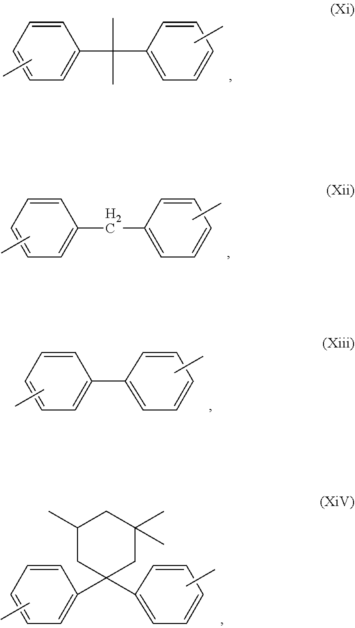

or the chlorinated and/or brominated derivatives thereof. X (together with the adjoining oxygen atoms) is preferably derived from hydroquinone, bisphenol A or diphenylphenol. It is likewise preferable for X to be derived from resorcinol. Particularly preferably, X is derived from bisphenol A. n in formula (10) is preferably equal to 1. q is preferably 0 to 20, particularly preferably 0 to 10, and in the case of mixtures is average values from 0.8 to 5.0, preferably 1.0 to 3.0, further preferably 1.05 to 2.00 and particularly preferably from 1.08 to 1.60.

The phosphorus compound of general formula (10) is preferably a compound of formula (11):

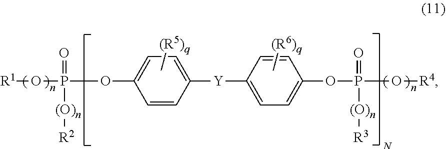

in which
R¹, R², R³ and R⁴ are each independently a linear or branched C₁—to Co-alkyl radical and/or optionally linear- or branched-alkyl-substituted C₅—to C₆-cycloalkyl radical, C₆—to C₁₀-aryl radical or C₇—to C₁₂-aralkyl radical,
n is independently 0 or 1,
q is independently 0, 1, 2, 3 or 4,
N is a number between 1 and 30,
R⁵ and R⁶ are independently linear or branched C₁—to C₄-alkyl radical, preferably methyl radical, and
Y is linear or branched C₁—to C₇-alkylidene, a linear or branched C₁—to C₇-alkylene radical,
C₅—to C₁₂-cycloalkylene radical, C₅—to C₁₂-cycloalkylidene radical, —O—, —S—, —SO—, SO₂ or —CO—.

Phosphorus compounds of formula (10) are in particular tributyl phosphate, triphenyl phosphate, tricresyl phosphate, diphenyl cresyl phosphate, diphenyl octyl phosphate, diphenyl 2-ethylcresyl phosphate, tri (isopropylphenyl)phosphate, resorcinol-bridged oligophosphate and bisphenol A-bridged oligophosphate. If phosphorus compounds of formula (10) are used, the use of oligomeric phosphoric esters of formula (10) which are derived from bisphenol A is especially preferred.

Further preference is given to using mixtures of identical structure and different chain length, with the stated q value being the average q value. The average q value is determined by determining the composition of the phosphorus compound mixture (molecular weight distribution) by means of high pressure liquid chromatography (HPLC) at 40° C. in a mixture of acetonitrile and water (50:50) and using this to calculate the average values of q.

Particularly preferably, bisphenol A-based oligophosphate (bisphenol A bis(diphenyl phosphate)) according to formula (12) with q=1 to 20, in particular with q=1.0 to 1.2, is present in the compositions according to the invention.

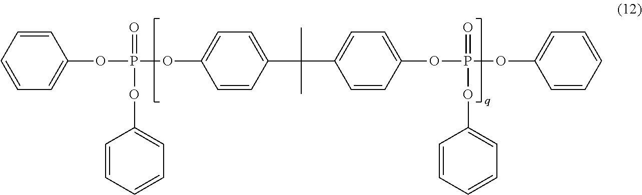

Phosphorus compounds of this kind are known (cf., for example, EP 0 363 608 A1, EP 0 640 655 A2) or can be prepared in an analogous manner by known methods (e.g. Ullmanns Enzyklopädie der technischen Chemie [Ullmann's Encyclopedia of Industrial Chemistry], vol. 18, p. 301 ff., 1979; Houben-Weyl, Methoden der organischen Chemie [Methods of Organic Chemistry], vol. 12/1, p. 43; Beilstein vol. 6, p. 177).

Alternatively, cyclic phosphazenes according to formula (13) are particularly preferably used as component C:

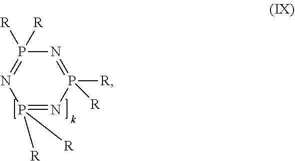

where
R in each case is identical or different and is
   an amine radical,
   an in each case optionally halogenated, preferably fluorine-halogenated, further preferably monohalogenated, C₁—to C₈-alkyl radical, preferably methyl radical, ethyl radical, propyl radical or butyl radical,
   a C₁—to C₈-alkoxy radical, preferably a methoxy radical, ethoxy radical, propoxy radical or butoxy radical,
   an in each case optionally alkyl-substituted, preferably C₁—to C₄-alkyl-substituted, and/or halogen-substituted, preferably chlorine- and/or bromine-substituted, C₅—to C₆-cycloalkyl radical,
   an in each case optionally alkyl-substituted, preferably C₁—to C₄-alkyl-substituted, and/or halogen-substituted, preferably chlorine-, bromine-, and/or hydroxy-substituted, C₆—to C₂₀-aryloxy radical, preferably phenoxy radical, naphthyloxy radical,
   an in each case optionally alkyl-substituted, preferably C₁—to C₄-alkyl-substituted, and/or halogen-substituted, preferably chlorine- and/or bromine-substituted, C₇—to C₁₂-aralkyl radical, preferably phenyl-C₁—to C₄-alkyl radical, or
   a halogen radical, preferably chlorine or fluorine, or
   an OH radical,
k is a whole number from 1 to 10, preferably a number from 1 to 8, particularly preferably 1 to 5, very particularly preferably 1.

Commercially available phosphazenes are preferably used here. These are typically mixtures of rings of different ring sizes.

Further preference is given, either individually or in a mixture, to: propoxyphosphazene, phenoxyphosphazene, methylphenoxyphosphazene, aminophosphazene, fluoroalkylphosphazenes, and also phosphazenes having the following structures:

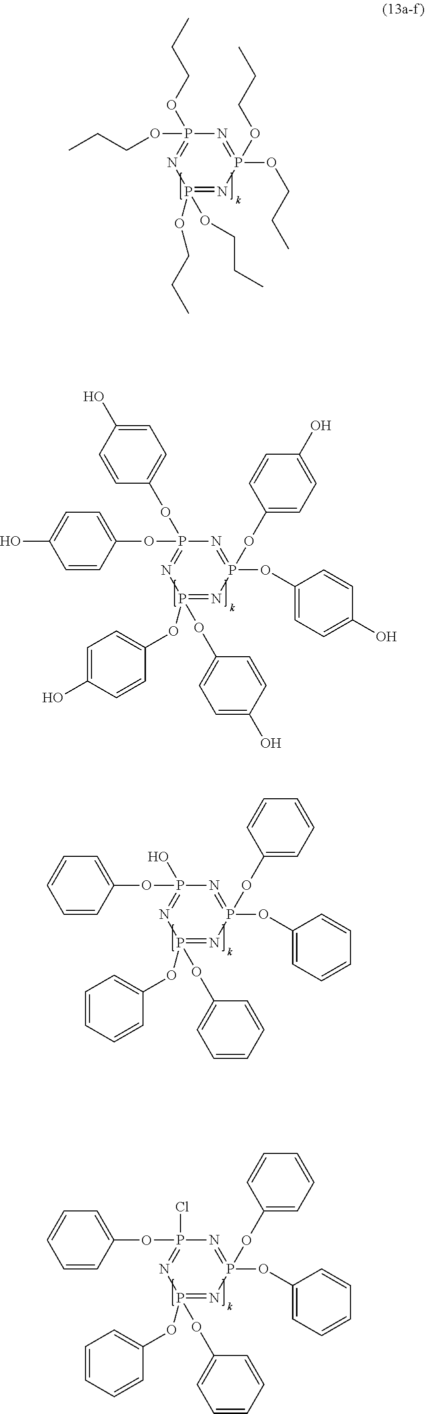

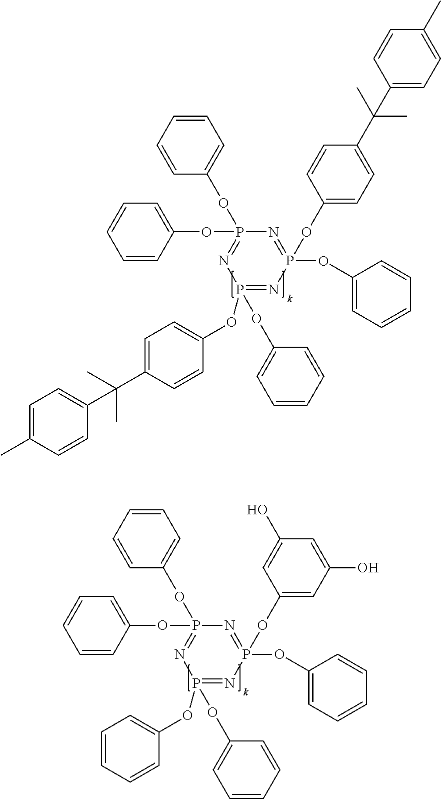

In the compounds 13a-f shown above, k=1, 2 or 3.

Preferably, the proportion of phosphazenes that are halogen-substituted on the phosphorus, for example composed of incompletely reacted starting material, is less than 1000 ppm, further preferably less than 500 ppm.

The phosphazenes can be used alone or in a mixture. The radical R may always be the same or two or more radicals in the formulae may be different. The radicals R of a phosphazene are preferably identical.

In one embodiment, solely phosphazenes having the same R are used.

Preferably, the proportion of tetramers (k=2) is from 2 to 50 mol %, based on component C, further preferably from 5 to 40 mol %, further preferably still from 10 to 30 mol %, particularly preferably from 10 to 22 mol %.

Preferably, the proportion of higher oligomeric phosphazenes (k=3, 4, 5, 6 and 7) is from 0 to 30 mol %, based on component C, further preferably from 2.5 to 25 mol %, further preferably still from 5 to 20 mol %, and particularly preferably from 6-15 mol %.

Preferably, the proportion of oligomers with k≥8 is from 0 to 2.0 mol %, based on component C, and preferably from 0.10 to 1.00 mol %.

Further preferably, the phosphazenes of component C satisfy all three above-mentioned conditions with respect to the proportions of oligomers.

Particularly preferably present as component C is phenoxyphosphazene (all R=phenoxy, formula 13g), alone or with further phosphazenes according to formula (13) as component C, with a proportion of oligomers with k=1 (hexaphenoxyphosphazene) of 50 to 98 mol %, particularly preferably 60 to 72% by weight, based on the amount of phenoxyphosphazene. If phenoxyphosphazene is used, the proportion of oligomers with k=2 is very particularly preferably: 15% to 22% by weight and with k≥3: 10% to 13% by weight.

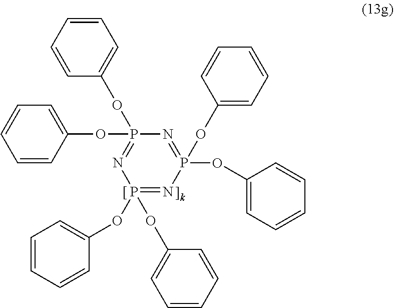

Alternatively, component C very particularly preferably comprises, and very particularly preferably is, a phenoxyphosphazene having a trimer proportion (k=1) of 70 to 85 mol %, a tetramer proportion (k=2) of 10 to 20 mol %, a proportion of higher oligomeric phosphazenes (k=3, 4, 5, 6 and 7) of 3 to 8 mol % and phosphazene oligomers with k≥8 of 0.1 to 1 mol %, based on component C.

In an alternative preferred embodiment, n, defined as the arithmetic mean of k, is in the range from 1.10 to 1.75, preferably from 1.15 to 1.50, further preferably from 1.20 to 1.45, and particularly preferably from 1.20 to 1.40 (range boundaries included).

$$n = \frac{{\sum }_{i = 1}^{max} {k}_{i} \cdot {x}_{i}}{{\sum }_{i = 1}^{max} {x}_{i}} \qquad ( 14 )$$

Phosphazenes and the preparation thereof are described, for example, in EP 728 811 A2, DE 1961668 A and WO 97/40092 A1.

The oligomer compositions in the respective blend samples can be detected and quantified after compounding by means of 31P NMR (chemical shift; δ trimer: 6.5 to 10.0 ppm; δ tetramer: −10 to −13.5 ppm; δ higher oligomers: −16.5 to −25.0 ppm).

Very particularly preferably, component C comprises bisphenol A-based oligophosphate according to formula (12) and/or cyclic phosphazene according to formula (13), most preferably component C is bisphenol A-based oligophosphate according to formula (12) and/or cyclic phosphazene according to formula (13), exceptionally preferably component C is cyclic phosphazene according to formula (13).

The proportion of phosphorus-containing flame retardant in the compositions according to the invention is 6% by weight to 14% by weight, preferably 7.0% by weight to 12.0% by weight, particularly preferably 8% to 10% by weight, based on the overall composition.

The quotient of the amount of component C, i.e. phosphorus-containing flame retardant, and the amount of component A, i.e. aromatic polycarbonate, based on the overall composition, multiplied by 100, here is >10.0, preferably ≥10.7, particularly preferably up to 25.

If the talc content is >37% by weight, preferably >35.5% by weight, particularly preferably >35% by weight, the phosphazene content is >10.0% by weight, preferably at least 12% by weight.

### Component D

The compositions according to the invention contain as component D a fluorine-containing anti-drip agent, which may be a mixture of two or more anti-drip agents. The total amount of anti-drip agent (anti-dripping agent) is 0.3% by weight to 2.0% by weight, preferably 0.4% by weight to 1.6% by weight, particularly preferably 0.045% by weight to 1.0% by weight of at least one anti-drip agent.

The anti-drip agent used is preferably fluorine-containing polymer, in particular polyolefin.

The fluorinated polyolefins used with preference as anti-drip agents have high molecular weight and have glass transition temperatures of above −30° C., generally of above 100° C., and fluorine contents preferably from 65% by weight to 76% by weight, in particular from 70% to 76% by weight. Preferred fluorinated polyolefins are polytetrafluoroethylene, polyvinylidene fluoride, tetrafluoroethylene/hexafluoropropylene copolymers and ethylene/tetrafluoroethylene copolymers. Fluorinated polyolefins are known (cf. “Vinyl and Related Polymers” by Schildknecht, John Wiley & Sons, Inc., New York, 1962, pages 484-494; “Fluoropolymers” by Wall, Wiley-Interscience, John Wiley & Sons, Inc., New York, volume 13, 1970, pages 623-654; “Modern Plastics Encyclopedia”, 1970-1971, volume 47, No. 10 A, October 1970, McGraw-Hill, Inc., New York, pages 134 and 774; “Modern Plastics Encyclopedia”, 1975-1976 October 1975, volume 52, No. 10 A, McGraw-Hill, Inc., New York, pages 27, 28 and 472 and U.S. Pat. No. 3,671,487 A, 3 723 373 A and 3 838 092 A). They can be prepared by known methods, for example by polymerizing tetrafluoroethylene in aqueous medium with a free-radical-forming catalyst, for example sodium, potassium or ammonium peroxydisulfate, at pressures from 7 to 71 kg/cm² and at temperatures from 0 to 200° C., preferably at temperatures from 20 to 100° C. Further details are described, for example, in U.S. Pat. No. 2,393,967 A.

Depending on the use form, the density of the fluorinated polyolefins can lie between 1.2 and 2.3 g/cm³, preferably 2.0 g/cm³ to 2.3 g/cm³, determined according to ISO 1183-1 (2019-09), and the average particle size between 0.05 and 1000 μm, determined by means of light microscopy or white light interferometry.

Suitable tetrafluoroethylene polymer powders are commercial products and are available by way of example from DuPont under the trade name Teflon®.

Particular preference is given to using polytetrafluoroethylene (PTFE), as such, but also in the form of a PTFE-containing composition, as fluorine-containing anti-drip agent. If a PTFE-containing composition is used, the minimum use amount thereof is enough for at least 0.2% by weight, preferably at least 0.21% by weight, particularly preferably at least 0.25% by weight, of PTFE to be present in the overall composition. The PTFE-containing compositions include Hostaflon® TF2021 or PTFE blends such as Blendex® B449 (about 50% by weight of PTFE and about 50% by weight of SAN [from 80% by weight of styrene and 20% by weight of acrylonitrile]) from Chemtura. Very particular preference is given to using PTFE or a PTFE/SAN blend as fluorine-containing anti-drip agent.

### Component E

Component E of the compositions according to the invention is an anhydride-modified α-olefin polymer.

The α-olefin polymer is preferably based on at least one monomer selected from the group consisting of ethylene, 1-propene, 1-butene, 1-isobutene, 1-pentene, 1-hexene, 1-heptene, 1-octene, 1-nonene, 1-decene, 1-undecene, 1-dodecene, 1-tridecene, 1-tetradecene, 1-octadecene, 1-nonadecene, but may also be based on mixtures of these monomers. Further preferably, the α-olefin polymer is based on at least one monomer selected from the group consisting of ethene, propene, 1-hexene, 1-octene. Particularly preferably, the α-olefin polymer is based on ethylene, propene and/or 1-octene.

In this context, “based on” means that preferably at least 90% by weight, further preferably at least 95% by weight, particularly preferably at least 98% by weight, based on the total weight of the respective α-olefin polymer, without anhydride modification, in the polycarbonate-containing composition, of the α-olefin polymer has been formed from the respective monomer(s).

The α-olefin polymer has been modified with an anhydride, using an unsaturated carboxylic anhydride for the modification. The carboxylic anhydride is preferably selected from the group consisting of maleic anhydride, phthalic anhydride, fumaric anhydride, itaconic anhydride and mixtures thereof. Particular preference is given to maleic anhydride.

The anhydride-modified α-olefin polymer is preferably free of styrene-butadiene rubber, very particularly preferably rubber-free.

A preferred anhydride-modified α-olefin polymer comprises
E1) 90.0-99.5% by weight, preferably 92.0-97.5% by weight, further preferably 94.0-97.0% by weight, of α-olefin polymer and
E2) 0.5-10.0% by weight, further preferably 2.5-8.0% by weight, further preferably still 3.0-6.0% by weight, of anhydride.

The olefinic portion E1) of the α-olefin polymer here is very particularly preferably characterized in that the ethylene proportion is 65.0-96.0% by weight, further preferably 80.0-96.0% by weight, very particularly preferably 84.0-92.0% by weight,
the propylene proportion is 2.0-10.0% by weight, very particularly preferably 4.0-8.0% by weight, and
the 1-octene proportion is 2.0-25.0% by weight, further preferably 2.0-10.0% by weight, very particularly preferably 4.0-8.0% by weight.

Very particularly preferably, the α-olefin polymer is not based on any further monomers.

Alternatively, the olefinic portion E1) of the alpha-olefin polymer is preferably based on propylene and/or ethylene, particularly preferably only on propylene, very particularly preferably to an extent of at least 98% by weight.

The average molecular weight M_{w} of the anhydride-modified α-olefin polymer is preferably 300 to 40 000 g/mol, further preferably 800 to 32 000 g/mol, further preferably still 1000 to 22 000 g/mol, particularly preferably 3000 to 21 000 g/mol. The molecular weight M_{w} is determined by means of gel permeation chromatography in ortho-dichlorobenzene at 150° C. with polystyrene calibration. Here, the value stated is preferably the average value from a duplicate determination.

The acid number of the anhydride-modified α-olefin polymer is preferably at least 30 mg KOH/g, further preferably 45 to 170 mg KOH/g, particularly preferably to 80 mg KOH/g, determined according to DIN ISO 17025:2005-08 by means of potentiometric titration with alcoholic potassium hydroxide solution.

Very particularly preferably, the anhydride-modified α-olefin polymer according to component E is based on propene, is maleic anhydride-modified and further preferably has an average molecular weight M_{w}, determined by means of gel permeation chromatography in ortho-dichlorobenzene at 150° C. with polystyrene calibration, of 1000 to 22 000 g/mol, further preferably still 3000 to 21 000 g/mol, and an acid number of 45 to 170 mg KOH/g, further preferably still of 50 to 100 mg KOH/g, determined according to DIN ISO 17025:2005-08 by means of potentiometric titration.

The amount of anhydride-modified α-olefin polymer in the overall composition is 1% by weight to 3% by weight, preferably 1.2% by weight to 2.5% by weight, further preferably 1.3% by weight to 2.3% by weight, particularly preferably 1.5% by weight to 2% by weight, in particular to 2.0% by weight.

### Further Additives (Component F)

The polycarbonate compositions according to the invention may contain one or more further additives different from components B, C, D and E, which are subsumed in the present case under “component F”.

Optionally (0% by weight), preferably up to 10% by weight, further preferably still 0.1% by weight to 5% by weight, particularly preferably 0.1% by weight to 3% by weight, very particularly preferably 0.2% by weight to 1.0% by weight, of other customary additives (“further additives”) are present, these percentages by weight being based on the total weight of the composition. The group of the further additives does not include any talc and any phosphorus-containing flame retardant according to component C. The group of the further additives also does not include any fluorine-containing anti-drip agent, as this is already described as component D, and also any anhydride-modified α-olefin polymer according to component E.

Such further additives, as are typically added to polycarbonates, are in particular heat stabilizers, antioxidants, mold-release agents, UV absorbers, IR absorbers, impact modifiers, antistats, flame retardants different from component C, optical brighteners, light-scattering agents, hydrolysis stabilizers, transesterification stabilizers, (organic) dyes, (organic/inorganic) pigments, for example titanium dioxide, compatibilizers and/or additives for laser marking, in particular in the amounts typical for polycarbonate-based compositions. Such additives are described, for example, in EP 0 839 623 A1, WO 96/15102 A1, EP 0 500 496 A1 or in “Plastics Additives Handbook”, Hans Zweifel, 5th Edition 2000, Hanser Verlag, Munich. These additives may be added individually or else in a mixture and are additives that are preferred according to the invention.

Further preferably present as further additives, where further additives are present at all, are one or more further additives selected from the group consisting of heat stabilizers, antioxidants, mold-release agents, organic dyes, organic pigments, inorganic pigments; exceptionally preferably there are no further additives. In this case, the proportion of the further additives is especially preferably 0% to 3% by weight. Very particularly preferably present as further additive is at least one heat stabilizer, an antioxidant and/or a mold-release agent, very particularly preferably a heat stabilizer.

It will be appreciated that only such additives may be added, and only in such amounts, if they do not significantly negatively impact the effect according to the invention of high CTI and good flame retardancy and preferably also do not lower the Vicat temperature, determined according to ISO 306:2014-3, VST method B, below 107° C., preferably below 120° C. Therefore, in addition to the phosphorus-containing flame retardants according to component C, it is particularly preferable for no more than 0.05% by weight of further flame retardants to be present. It is very particularly preferable for no further flame retardants at all to be present.

The compositions according to the invention may indeed contain, in addition to component C, further flame retardants, but are free of those selected from the group of alkali metal, alkaline earth metal or ammonium salts of aliphatic or aromatic sulfonic acid, sulfonamide or sulfonimide derivatives, and combinations thereof, with “derivatives” being understood to mean those compounds having a molecular structure that in place of a hydrogen atom or a functional group possesses a different atom or a different atom group or in which one or more atoms/atom groups has/have been removed. The parent compound is thus still recognizable.

Such flame retardants that are not present in the compositions according to the invention are in particular one or more compounds selected from the group consisting of sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium diphenylsulfone sulfonate, sodium or potassium 2-formylbenzenesulfonate, sodium or potassium (N-benzenesulfonyl)benzenesulfonamide, or mixtures thereof, among these particularly preferably sodium or potassium perfluorobutanesulfate, sodium or potassium perfluorooctanesulfate, sodium or potassium diphenylsulfone sulfonate, or mixtures thereof, especially potassium perfluoro-1-butanesulfonate, which is commercially available, inter alia, as Bayowet® C₄ from Lanxess, Leverkusen, Germany.

Additives that are particularly preferably present are mold-release agents, further preferably based on a fatty acid ester, further preferably still based on a stearic ester, especially preferably based on pentaerythritol. Particular preference is given to using pentaerythritol tetrastearate (PETS) and/or glycerol monostearate (GMS). If one or more mold-release agents are used, the amount is preferably up to 1.0% by weight (inclusive), further preferably 0.01% to 0.7% by weight, particularly preferably 0.02% to 0.60% by weight, based in each case on the overall composition.

Additives that are particularly preferably present are also heat stabilizers. The amount of heat stabilizer is preferably up to 0.20% by weight, further preferably 0.01% to 0.10% by weight, further preferably still 0.01% to 0.05% by weight, particularly preferably 0.015% to 0.040% by weight, based on the overall composition.

Suitable heat stabilizers are in particular phosphorus-based stabilizers selected from the group of the phosphates, phosphites, phosphonites, phosphines and mixtures thereof. Examples include triphenyl phosphite, diphenyl alkyl phosphite, phenyl dialkyl phosphite, tris(nonylphenyl) phosphite, trilauryl phosphite, trioctadecyl phosphite, distearyl pentaerythritol diphosphite, tris(2,4-di-tert-butylphenyl)phosphite (Irgafos® 168), diisodecyl pentaerythritol diphosphite, bis(2,4-di-tert-butylphenyl) pentaerythritol diphosphite, bis(2,4-dicumylphenyl) pentaerythritol diphosphite (Doverphos® S-9228), bis(2,6-di-tert-butyl-4-methylphenyl) pentaerythritol diphosphite, diisodecyloxy pentaerythritol diphosphite, bis(2,4-di-tert-butyl-6-methylphenyl) pentaerythritol diphosphite, bis(2,4,6-tris(tert-butylphenyl) pentaerythritol diphosphite, tristearyl sorbitol triphosphite, tetrakis(2,4-di-tert-butylphenyl)-6-isooctyloxy-2,4,8,10-tetra-tert-butyl-12H-dibenzo[d,g]-1,3,2-4,4′-biphenylenediphosphonite, dioxaphosphocine, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyldibenzo[d,g]-1,3,2-dioxaphosphocine, 2,2′,2″-nitrilo [triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, bis(2,6-di-tert-butyl-4-methylphenyl) pentaerythritol diphosphite, triphenylphosphine (TPP), trialkylphenylphosphine, bisdiphenylphosphinoethane or a trinaphthylphosphine. They are used alone or in a mixture, for example Irganox® B900 (mixture of Irgafos® 168 and Irganox® 1076 in a 4:1 ratio) or Doverphos® S-9228 with Irganox® B900 or Irganox® 1076. Especially preferably, triphenylphosphine (TPP), Irgafos® 168 or tris(nonylphenyl) phosphite, or mixtures thereof, are used.

It is also possible to use phenolic antioxidants such as alkylated monophenols, alkylated thioalkylphenols, hydroquinones and alkylated hydroquinones. Particular preference is given to using Irganox® 1010 (pentaerythritol 3-(4-hydroxy-3,5-di-tert-butylphenyl) propionate; CAS: 6683-19-8) and Irganox 1076® (octadecyl 3-(3,5-di-tert-butyl-4-hydroxyphenyl) propionate), preferably in amounts of 0.05%-0.5% by weight.

It is also possible to add sulfonic esters or alkyl phosphates, for example mono-, di- and/or trihexyl phosphate, triisooctyl phosphate and/or trinonyl phosphate, as transesterification inhibitors. The alkyl phosphate used is preferably triisooctyl phosphate (tris-2-ethylhexyl phosphate). It is also possible to use mixtures of various mono-, di- and trialkyl phosphates. Triisooctyl phosphate is preferably used in amounts from 0.003% by weight to 0.05% by weight, further preferably 0.005% by weight to 0.04% by weight and particularly preferably from 0.01% by weight to 0.03% by weight, based on the overall composition.

Examples of impact modifiers are: core-shell polymers such as ABS or MBS; olefin-acrylate copolymers such as the Elvaloy® types from DuPont or Paraloid® types from Dow; silicone acrylate rubbers such as the Metablen® types from Mitsubishi Rayon Co., Ltd. The compositions according to the invention already have an exceptional profile of properties without additional impact modifiers. Compositions according to the invention are therefore preferably free of impact modifiers.

Particularly preferably, the compositions according to the invention do not contain any further fillers, such as barium sulfate, in addition to the talc. Titanium dioxide is not considered here to be a “filler”, but rather a white pigment.

The polymer compositions according to the invention, containing the mixed components A, B, C, D, E and optionally F and optionally further constituents, may be prepared using powder premixes. It is also possible to use premixes of pellet materials or pellet materials and powders with the additions according to the invention. It is also possible to use premixes produced from solutions of the mixture components in suitable solvents, wherein homogenization is optionally effected in solution and the solvent is then removed. In particular, the additives referred to as component F and also further constituents of the compositions according to the invention can be introduced by known methods or in the form of a masterbatch. The use of masterbatches is preferred in particular for the introduction of additives and further constituents, with masterbatches based on the respective polymer matrix being used in particular.

The compositions according to the invention may for example be extruded. After extrusion, the extrudate may be cooled and comminuted. The combining and mixing of a premix in the melt may also be effected in the plasticizing unit of an injection molding machine. In this case, the melt is directly converted into a molded article in the subsequent step.

Compositions according to the invention are preferably used for the production of moldings for components from the EE sector, in particular for high-voltage switches, inverters, relays, electronic connectors, electrical connectors, circuit breakers, components for photovoltaic applications, electric motors, heat sinks, chargers or charging plugs for electric vehicles, electrical junction boxes, smart meter housings, miniature circuit breakers, busbars. The invention thus also provides moldings which are part of a corresponding EE component. “Part” can be an individual element of a complex product, but equally also the entire element.

The invention thus provides moldings consisting of, or comprising regions made from, compositions according to the invention, and also corresponding components comprising elements, i.e. moldings, which consist of compositions according to the invention or comprise regions consisting of compositions according to the invention.

A molding in the sense according to the invention is also an insulation layer made from the composition according to the invention. Such a layer can for example be provided on an inverter as a layer to protect against external influences. For inverters, standard insulation materials are those having a CTI of 600 V. The composition according to the invention may also be used as an insulation layer for other electrical components, for example transistors. The insulation layer creates for example a secure separation between the transistor and a metallic heat sink.

The moldings consisting of, or comprising a region made from, a thermoplastic composition according to the invention or layers of a thermoplastic composition according to the invention are preferably used in those EE components that are designed for an operating voltage of at least 375 V, preferably of at least 400 V. It can however also be designed for a typical household operating voltage of 230 V±23 V in Europe, although lower distances between the electrical conductors can now be achieved.

The high comparative tracking index of the polycarbonate compositions according to the invention makes it possible, using the polycarbonate material, to achieve smaller distances between two electrical conductors of a component than was previously possible with the use of polycarbonate.

The invention thus also provides an EE component, comprising a first electrical conductor and a second electrical conductor at a first distance d1 and a second distance d2 with respect to one another,
which are connected via an element made from a thermoplastic composition according to the invention, the latter being in direct contact with the first electrical conductor and the second electrical conductor,
wherein the distance d1 is the shortest distance between the first electrical conductor and the second electrical conductor along the surface of the element made from the thermoplastic composition and
wherein the distance d2 is the shortest distance between the first electrical conductor and the second electrical conductor through the air,
wherein d2 is selected in such a way that at the respective operating voltage a sparkover through the air is prevented and
wherein d1, at the operating voltage U listed below, is:

$$\begin{matrix}d 1 i ( 0 V \leq U \leq 250 V ) : 1.8 mm to < 2.5 mm \\ d 1 ii ( 250 V < U \leq 500 V ) = 3.6 mm to < 5. mm \\ d 1 iii ( 500 V < U \leq 1000 V ) = 7.1 mm to < 10. mm .\end{matrix}$$

Such small distances are only achievable with a material that has at least a CTI of 400 V.

“Element made from a thermoplastic composition according to the invention” here means that an element is present which consists of a thermoplastic composition according to the invention, i.e. the composition has not been mixed with additional components.

If the material has a CTI of 600 V, even smaller distances are achievable, such that d1, at the operating voltage listed, is then preferably:

$$\begin{matrix}d 1 i ( 0 V \leq U \leq 250 V ) : 1.3 mm to < 2.5 mm , \\ d 1 ii ( 250 V < U \leq 500 V ) = 2.5 mm to < 5. mm , \\ d 1 iii ( 500 V < U \leq 1000 V ) = 5. mm to < 10. mm .\end{matrix}$$

When using a material with a CTI of 600 V, d1, at the operating voltage listed, is particularly preferably:

$$\begin{matrix}d 1 i ( 0 V \leq U \leq 250 V ) : 1.3 mm to < 1.8 mm , \\ d 1 ii ( 250 V < U \leq 500 V ) = 2.5 mm to < 3.6 mm , \\ d 1 iii ( 500 V < U \leq 1000 V ) = 5. mm to < 7.1 mm .\end{matrix}$$

distances that are not achievable even with a material with a CTI of 400 or 450 V, but require a CTI of 600 V.

The invention thus also provides corresponding EE components in which corresponding distances are achieved and which preferably have an operating voltage to be applied of at least 375 V, preferably of at least 400 V, particularly preferably of at least 600 V.

The selection of d2 is within the ability of those skilled in the art. Preferably, d2 is at least 1.2 mm.

The invention likewise provides for the use of compositions according to the invention, also in the embodiments described as preferred, particularly preferred etc., for achieving the aforementioned small distances between electrical conductors in EE components.

The invention further provides for the use of compositions according to the invention for attaining a CTI of at least 400 V, preferably of at least 600 V, further preferably in combination with a thermal conductivity (in-plane) of at least 0.9 W/(mK), determined according to ASTM E 1461-13. It will be appreciated that the embodiments of the composition according to the invention that are referred to as preferred, further preferred, particularly preferred etc. also apply to the uses according to the invention.

It is well known that the degree of soiling affects the electrical conductivity. The distances d1 and d2 mentioned are usable in practice in components in which, for example due to structural shielding, an IP6K9K degree of protection according to ISO 20653:2013-02 is adhered to.

Thermoplastic compositions that are preferred according to the invention belong to insulating material group II (400 V≤CTI<600 V), very particularly preferred compositions belong to insulating material group I (600 V≤CTI), classified according to DIN EN 60664-1:2008.

They have a thermal conductivity (in-plane) of preferably at least 0.9 W/(mK), determined according to ASTM E 1461-13, and so good heat dissipation can additionally be achieved.

Various embodiments of the present invention are described below:
1. A thermoplastic composition, containing
   A) at least 44.5% by weight of aromatic polycarbonate, wherein the aromatic polycarbonate comprises one or more monomer units of formula (1a)

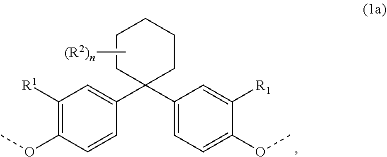

in which
   R¹ is hydrogen or a C₁—to C₄-alkyl radical,
   R² is a C₁—to C₄-alkyl radical,
   n is 0, 1, 2 or 3,
in a proportion of 30%-65% by weight, based on the total weight of the aromatic polycarbonate,
B) 30% to 40% by weight of talc,
C) 6% to 14% by weight of phosphorus-containing flame retardant, wherein the quotient of
the amount of component C, based on the overall composition, and
the amount of component A, based on the overall composition,
multiplied by 100,
is >10.0,
D) 0.3% to 2.0% by weight of fluorine-containing anti-drip agent,
E) 1% to 3% by weight of anhydride-modified α-olefin polymer,
wherein, if the talc content is <35.0% by weight, the proportion of monomer units of formula (1a), based on the total weight of the aromatic polycarbonate, is at least 35% by weight and
wherein, if the talc content is >37% by weight, the phosphazene content is >10.0% by weight.
2. The thermoplastic composition according to embodiment 1, wherein the proportion of monomer units of formula (1a), based on the total weight of the aromatic polycarbonate, is 40% to 60% by weight, in particular 40% to 50% by weight.
3. The thermoplastic composition according to embodiment 1 or 2, wherein the talc content of the thermoplastic composition is 30% to 35% by weight.
The thermoplastic composition according to any of the preceding embodiments, wherein the amount of fluorine-containing anti-drip agent is 0.4% to 1.0% by weight.
5. The thermoplastic composition according to any of the preceding embodiments, wherein the amount of aromatic polycarbonate is at least 50% by weight.
6. The thermoplastic composition according to embodiment 1 or any of embodiments 3 to 5, wherein the proportion of monomer units of formula (1a), based on the total weight of the aromatic polycarbonate, is up to 60% by weight, based on the total weight of aromatic polycarbonate.
7. The thermoplastic composition according to any of the preceding embodiments, wherein the phosphorus-containing flame retardant is a phosphazene or a mixture of different phosphazenes.
8. The thermoplastic composition according to any of the preceding embodiments, wherein the anhydride-modified α-olefin polymer comprises maleic anhydride-modified propylene polymer.
9. The thermoplastic composition according to any of the preceding embodiments, wherein the composition contains 0.2% to 2.0% by weight of titanium dioxide.
10. The thermoplastic composition according to any of the preceding embodiments, wherein, if the talc content is <35% by weight, the proportion of monomer units of formula (1a), based on the total weight of the aromatic polycarbonate, is at least 40% by weight.
11. The thermoplastic composition according to any of the preceding embodiments, wherein the quotient of the amount of component C, based on the overall composition, and the amount of component A, based on the overall composition, multiplied by 100, is ≥10.7.
12. The thermoplastic composition according to any of the preceding embodiments, wherein the quotient of the amount of component C, based on the overall composition, and the amount of component A, based on the overall composition, multiplied by 100, is ≤25.
13. The thermoplastic composition according to any of the preceding embodiments, wherein, if the talc content is >35.5% by weight, the phosphazene content is >10.0% by weight, preferably at least 12% by weight.
14. The thermoplastic composition according to any of the preceding embodiments, containing
   A) at least 50% by weight of aromatic polycarbonate, wherein the aromatic polycarbonate comprises one or more monomer units of formula (1a)

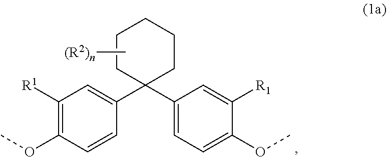

in which
   R¹ is hydrogen or a C₁—to C₄-alkyl radical,
   R² is a C₁—to C₄-alkyl radical,
   n is 0, 1, 2 or 3,
in a proportion of 30% to 65% by weight, preferably to 60% by weight, based on the total weight of the aromatic polycarbonate,
B) 30% to 35% by weight of talc,
C) 6% to 12% by weight of phosphorus-containing flame retardant, wherein the quotient of
the amount of component C, based on the overall composition, and
the amount of component A, based on the overall composition,
multiplied by 100,
is >10.0,
D) 0.3% to 2.0% by weight of fluorine-containing anti-drip agent,
E) 1% to 3% by weight of anhydride-modified α-olefin polymer,
wherein, if the talc content is <35.0% by weight, the proportion of monomer units of formula (1a), based on the total weight of the aromatic polycarbonate, is at least 35% by weight, preferably at least 40% by weight.
15. The thermoplastic composition according to embodiment 14, wherein the proportion of monomer units of formula (1a), based on the total weight of the aromatic polycarbonate, is 35% to 45% by weight and the amount of phosphorus-containing flame retardant is 8% to 10% by weight.
16. The thermoplastic composition according to any of embodiments 1 to 13, consisting of
   A) at least 44.5% by weight of aromatic polycarbonate, wherein the aromatic polycarbonate comprises one or more monomer units of formula (1a)

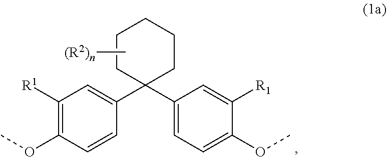

in which
   R¹ is hydrogen or a C₁—to C₄-alkyl radical,
   R² is a C₁—to C₄-alkyl radical,
   n is 0, 1, 2 or 3,
in a proportion of 30% to 65% by weight, based on the total weight of the aromatic polycarbonate,
B) 30% to 40% by weight of talc,
C) 6% to 14% by weight of phosphorus-containing flame retardant, wherein the quotient of
the amount of component C, based on the overall composition, and
the amount of component A, based on the overall composition,
multiplied by 100,
is >10.0,
D) 0.3% to 2.0% by weight of fluorine-containing anti-drip agent,
E) 1% to 3% by weight of anhydride-modified α-olefin polymer,
F) optionally one or more further additive(s), selected from the group consisting of heat stabilizers, antioxidants, mold-release agents, UV absorbers, IR absorbers, impact modifiers, antistats, flame retardants different from component C, optical brighteners, light-scattering agents, hydrolysis stabilizers, transesterification stabilizers, organic dyes, organic or inorganic pigments, compatibilizers, additives for laser marking,
wherein, if the talc content is <35.0% by weight, the proportion of monomer units of formula (1a), based on the total weight of the aromatic polycarbonate, is at least 35% by weight and
wherein, if the talc content is >37% by weight, the phosphazene content is >10.0% by weight.
17. The thermoplastic composition according to any of the preceding embodiments, wherein the phosphorus-containing flame retardant comprises a cyclic phosphazene and/or a phosphorus compound of formula (10).
18. The thermoplastic composition according to any of the preceding embodiments, wherein the phosphorus-containing flame retardant is a cyclic phosphazene and/or a phosphorus compound of formula (10)

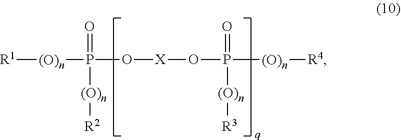

in which
R¹, R², R³ and R⁴ are independently a C₁—to C₈-alkyl radical, in each case optionally halogenated and in each case branched or unbranched, and/or C₅—to C₆-cycloalkyl radical, C₆—to C₂₀-aryl radical or C₇- to C₁₂-aralkyl radical, in each case optionally substituted by branched or unbranched alkyl, and/or halogen, preferably chlorine and/or bromine,
n is independently 0 or 1,
q is a value from 0 to 30 and
X is a mono- or polycyclic aromatic radical having 6 to 30 carbon atoms or a linear or branched aliphatic radical having 2 to 30 carbon atoms, each of which may be substituted or unsubstituted, and bridged or unbridged.
19. The thermoplastic composition according to embodiment 17 or 18, wherein the cyclic phosphazene is a phosphazene of formula (13)

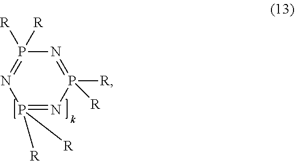

where
R in each case is identical or different and is
   an amine radical,
   an in each case optionally halogenated, preferably fluorine-halogenated, further preferably monohalogenated, C₁—to C₈-alkyl radical, preferably methyl radical, ethyl radical, propyl radical or butyl radical,
   a C₁—to C₈-alkoxy radical, preferably a methoxy radical, ethoxy radical, propoxy radical or butoxy radical,
   an in each case optionally alkyl-substituted, preferably C₁—to C₄-alkyl-substituted, and/or halogen-substituted, preferably chlorine- and/or bromine-substituted, C₅—to C₆-cycloalkyl radical,
   an in each case optionally alkyl-substituted, preferably C₁—to C₄-alkyl-substituted, and/or halogen-substituted, preferably chlorine-, bromine-, and/or hydroxy-substituted, C₆—to C₂₀-aryloxy radical, preferably phenoxy radical, naphthyloxy radical,
   an in each case optionally alkyl-substituted, preferably C₁—to C₄-alkyl-substituted, and/or halogen-substituted, preferably chlorine- and/or bromine-substituted, C₇—to C₁₂-aralkyl radical, preferably phenyl-C₁—to C₄-alkyl radical, or
   a halogen radical, preferably chlorine or fluorine, or
   an OH radical,
k is a whole number from 1 to 10, preferably a number from 1 to 8, particularly preferably 1 to 5, very particularly preferably 1.
20. The thermoplastic composition according to embodiment 17, 18 or 19, wherein the phosphorus compound of formula (10) is a bisphenol A-based oligophosphate of formula (12)

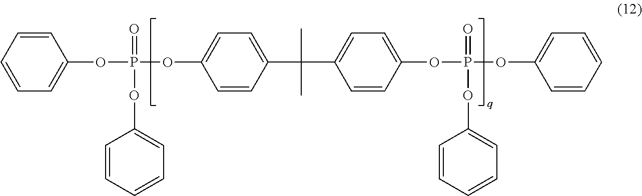

with q=1 to 20, in particular with q=1.0 to 1.2.
21. The thermoplastic composition according to any of the preceding embodiments, wherein the anhydride-modified α-olefin polymer according to component E is based on propene, is maleic anhydride-modified and preferably has an average molecular weight M_{w}, determined by means of gel permeation chromatography in ortho-dichlorobenzene at 150° C. with polystyrene calibration, of 1000 to 22 000 g/mol, preferably 3000 to 21 000 g/mol, and an acid number of 45 to 170 mg KOH/g, preferably of 50 to 100 mg KOH/g, determined according to DIN ISO 17025:2005-08 by means of potentiometric titration.
22. The thermoplastic composition according to any of the preceding embodiments, wherein the monomer units of formula (1a) are those in which R¹ is hydrogen, R² is a methyl radical and n is 3.
23. The thermoplastic composition according to any of the preceding embodiments, wherein the aromatic polycarbonate is APEC® or comprises APEC®.
24. The thermoplastic composition according to any of the preceding embodiments, wherein the aromatic polycarbonate contains 40% to 55% by weight, in particular to 50% by weight, based on the total weight of the aromatic polycarbonate, of one or more monomer units of formula (1a)

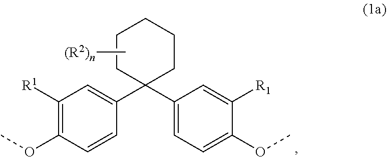

in which
   R¹ is hydrogen or a C₁—to C₄-alkyl radical,
   R² is a C₁—to C₄-alkyl radical,
   n is 0, 1, 2 or 3.
25. A molding consisting of, or comprising a region made from, a thermoplastic composition according to any of the preceding embodiments.
26. The molding according to embodiment 25, wherein the molding is part of a high-voltage switch, inverter, relay, electronic connector, electrical connector, circuit breaker, a photovoltaic system, an electric motor, a heat sink, a charger or charging plug for electric vehicles, an electrical junction box, a smart meter housing, a miniature circuit breaker, a busbar.
27. An EE component, which is designed for an operating voltage of at least 375 V, comprising a molding according to embodiment 25 or 26 or a layer made from a thermoplastic composition according to any of embodiments 1 to 24.
28. An EE component, which is designed for an operating voltage of 400 V, comprising a molding according to embodiment 24 or 25 or a layer made from a thermoplastic composition according to any of embodiments 1 to 24.
29. An EE component, comprising
   a first electrical conductor and a second electrical conductor at a first distance d1 and a second distance d2 with respect to one another,
   which are connected via an element made from a thermoplastic composition according to any of embodiments 1 to 24, which is in direct contact with the first electrical conductor and the second electrical conductor,
   wherein the distance d1 is the shortest distance between the first electrical conductor and the second electrical conductor along the surface of the element made from the thermoplastic composition and
   wherein the distance d2 is the shortest distance between the first electrical conductor and the second electrical conductor through the air,
   wherein d2 is selected in such a way that at the respective operating voltage a sparkover through the air is prevented and
   wherein d1, at the operating voltage U listed below, is:

$$\begin{matrix}d 1 i ( 0 V \leq U \leq 250 V ) : 1.8 mm to < 2.5 mm \\ d 1 ii ( 250 V < U \leq 500 V ) = 3.6 mm to < 5. mm \\ d 1 iii ( 500 V < U \leq 1000 V ) = 7.1 mm to < 10. mm .\end{matrix}$$

30. An EE component, comprising
   a first electrical conductor and a second electrical conductor at a first distance d1 and a second distance d2 with respect to one another,
   which are connected via an element made from a thermoplastic composition according to any of embodiments 1 to 24, which is in direct contact with the first electrical conductor and the second electrical conductor,
   wherein the distance d1 is the shortest distance between the first electrical conductor and the second electrical conductor along the surface of the element made from the thermoplastic composition and
   wherein the distance d2 is the shortest distance between the first electrical conductor and the second electrical conductor through the air,
   wherein d2 is selected in such a way that at the respective operating voltage a sparkover through the air is prevented,
   preferably according to either of embodiments 27 and 28, wherein d1, at the operating voltage U listed below, is:

$$\begin{matrix}d 1 i ( 0 V \leq U \leq 250 V ) : 1.3 mm to < 2.5 mm , preferably < 1.8 mm , \\ d 1 ii ( 250 V < U \leq 500 V ) = 2.5 mm to < 5. mm , preferably < 3.6 mm , \\ d 1 iii ( 500 V < U \leq 1000 V ) = 5. mm to < 10. mm , preferably < 7.1 mm .\end{matrix}$$

31. The EE component according to any of embodiments 27 to 30, wherein d2 is ≥1.2 mm.
32. The EE component according to any of embodiments 27 to 31, wherein the EE component is a high-voltage switch, inverter, relay, electronic connector, electrical connector, circuit breaker, part of a photovoltaic system, part of an electric motor, of a heat sink, of a charger or charging plug for electric vehicles, part of an electrical junction box, part of a smart meter housing, part of a miniature circuit breaker, part of a busbar.
33. The EE component according to any of embodiments 27 to 32, with an IP6K9K degree of protection according to ISO 20653:2013-02.

### Examples

### 1. Description of Raw Materials and Test Methods

### a) Raw Materials

Component A-1: Linear polycarbonate based on bisphenol A having a melt volume flow rate of 12 cm³/(10 min) (according to ISO 1133:2012-03, at a test temperature of 300° C. and with 1.2 kg load) containing as component F-2 250 ppm (=0.025% by weight, based on the total weight of component A) of triphenylphosphine heat stabilizer.

Component A-2: Linear copolycarbonate based on bisphenol A and bisphenol TMC (66% by weight) having an MVR of 8 cm³/10 min (330° C./2.16 kg, ISO 1133-1:2011) and a softening temperature (VST/B 120; ISO 306:2013) of 203° C.

Component A-3: Linear copolycarbonate based on bisphenol A and bisphenol TMC (13% by weight) having an MVR of 45 cm³/10 min (330° C./2.16 kg, ISO 1133-1:2011) and a softening temperature (VST/B 120; ISO 306:2013) of 158° C.

Component B-1: Compacted talc having a talc content of 98% by weight, an iron oxide content of 1.9% by weight, an aluminum oxide content of 0.2% by weight, ignition loss (DIN 51081/1000° C.) of 5.4% by weight, pH (according to EN ISO 787-9:1995) of 9.15, D (0.5) (sedimentation analysis) of 2.2 μm; BET surface area according to ISO 4652:2012-06 of 10 m²/g, brand: Finntalc M05SLC, manufacturer: Mondo Minerals B. V.

Component B*-2: Glass fiber from Nittobo (2-4-1, Kojimachi, Chiyoda-ku, Tokyo 102-8489, Japan) which is available under the trade name CSG 3PA-830. This is a flat glass fiber having a cut length of 3 mm and a cross-sectional ratio of 1.4.

Component B*-3: Amosil FW 600 fired silicon dioxide from Quarzwerke GmbH in Frechen, unsized, with an average particle size D (0.5) of approx. 4 μm, D (0.98) of approx. 13 μm, a D (0.1)/D (0.9) ratio of approx. 1.5/10 and a specific surface area of approx. 6 m²/g, determined according to DIN-ISO 9277:2014-01.

Component C-1: Rabitle FP110 phenoxycyclophosphazene from Fushimi Pharmaceutical, Japan, formula (13g), with a trimer proportion (k=1) of approximately 68 mol %.

Component D-1: ADS5000 SAN-encapsulated polytetrafluoroethylene (approx. 50% by weight PTFE (fluorine-containing anti-drip agent) and approx. 50% by weight SAN) from Chemical Innovation Co., Ltd. Thailand.

Component E-1: Propylene-maleic anhydride polymer having an average molecular weight (gel permeation chromatography in ortho-dichlorobenzene at 150° C. with polystyrene calibration) M_{w}=20 700 g/mol, Mn=1460 g/mol, acid number 78 mg KOH/g, determined according to DIN ISO 17025:2005-08 by means of potentiometric titration.

Component F-1: Titanium dioxide from Kronos having a D50=210 nm (scanning electron microscopy, ECD method; Kronos® 2230).

The bisphenol TMC content (“TMC %”) indicates the proportion (in % by weight) of bisphenol TMC as monomer unit in the aromatic polycarbonate.

### b) Test Methods

### Comparative Tracking Index (CTI):

In order to determine the comparative tracking index, the compositions described here were tested according to the rapid test method based on IEC 60112:2009. To this end, a 0.1% ammonium chloride test solution (395 ohm*cm resistance) was applied dropwise, between two neighboring electrodes spaced apart by 4 mm, to the surface of test specimens of dimensions 60 mm×40 mm×4 mm at a time interval of 30 s. A test voltage was applied between the electrodes and was varied over the course of the test. The first test specimen was tested at a starting voltage of 300 V or 350 V. A maximum of 50 drops (one drop every 30 s) in total were applied per voltage as long as no tracking current >0.5 A over 2 s occurred or the sample burned. After 50 drops, the voltage was increased by 50 V and a new test specimen was tested at this higher voltage, according to the procedure described above. This process was continued until either 600 V was reached or a tracking current or burning occurred. If one of the above-mentioned effects already occurred with fewer than 50 drops, the voltage was reduced by 25 V and a new test specimen was tested at this lower voltage. The voltage was reduced until the test was passed with 50 drops without tracking current or burning. This procedure was therefore used to determine the maximum possible voltage at which a composition was able to withstand 50 drops of the test solution without occurrence of a tracking current. Lastly, four further test specimens were tested at the determined maximum voltage with 50 drops each for confirmation. This confirmed value is reported as the CTI in the examples. A 100-drop value was not determined, hence “rapid test method based on” the specified standard.

### Flame Retardancy:

The flame retardancy of the polycarbonate compositions was tested according to Underwriters Laboratories method UL 94 V in thicknesses of 1.5 mm-3 mm. The tested test bars were conditioned beforehand for 7 days at 50% relative humidity and 70° C. ambient temperature.

Various fire classes are assigned depending on the behavior of the test specimens. This includes the time until the flame is extinguished, resistance to dripping, or whether a material produces burning drips. The classes determined hereafter are designated V0, V1 and V2 and are ascertained on the basis of a total of five tested test specimens.
V0: The test specimen, positioned with its longitudinal axis 180° (vertical) to the flame, has an average afterflame time after removal of the flame of not more than 10 s and does not produce any dripping plastic particles that ignite cotton wool located under the test specimen. The total afterflame time of five test specimens, in each case with two times flame application, is at most 50 s.
V1: In contrast to V0, the average maximum afterflame time here is <30 s, and here too no dripping particles or ignition of the cotton wool are permitted. The total afterflame time of five test specimens, in each case with two times flame application, is <250 s.
V2: In contrast to V0 and V1, dripping plastic particles that ignite the cotton wool are formed in this classification. The individual afterflame times are <30 s and the total afterflame time of 5 test specimens, in each case with two times flame application, is <250 s.
f.: The test does not deliver a flame retardancy classification if the afterflame times are exceeded.
FOT: Flame Out Time (afterflame time), reported in seconds.

### Heat Distortion Resistance:

The heat distortion resistance of the compositions was determined on the basis of the Vicat softening temperature (method B, test force 50 N, heating rate 50 K/h) on test specimens having the dimensions 80 mm×10 mm×4 mm according to ISO 306:2014-3.

### Thermal Conductivity:

The thermal conductivity was determined on injection-molded test specimens having the dimensions 60×60×2 mm³ according to ASTM E 1461-13 (Nano Flash method). “In-plane” means measured in the x,y direction.

### 2. Production of the Test Specimens

The compositions were prepared on a BUSS kneader. The melt temperature, rotational speed, throughput and torque had to be adjusted according to the procedure that is common knowledge to those skilled in the art and tailored to the respective composition. The filler was generally metered in via the side extruder. The test specimens having the dimensions 60 mm×40 mm×4 mm were produced from the molding compounds using standard injection molding methods at a melt temperature of 280° C. and a mold temperature of 80° C.

### 3. Results

In the tables below, “n.t.” means “not tested” and “f.” means “failed”.

As Table 1 shows, the increasing bisphenol TMC content only has a minimally positive effect on the CTI, but results in a worse flame retardancy, this becoming clear particularly from the afterflame times, which are significantly higher than in the case of pure homopolycarbonate (V-1). The thermal conductivity is only insignificantly reduced with increasing bisphenol TMC content in the tested range.

TABLE 1

| | | | V-1 | V-2 | V-3 | V-4 | V-5 | V-6 | V-7 | V-8 |
|---|---|---|---|---|---|---|---|---|---|---|
| A-1 | [% by wt.] | | 67.0 | 57.0 | 46.5 | 36.5 | 26.2 | 16.0 | 6.0 | |
| A-2 | [% by wt.] | | | 10.0 | 20.5 | 30.5 | 40.8 | 51.0 | 61.0 | 67.0 |
| B-3 | [% by wt.] | | 30.0 | 30.0 | 30.0 | 30.0 | 30.0 | 30.0 | 30.0 | 30.0 |
| E-1 | [% by wt.] | | 1.5 | 1.5 | 1.5 | 1.5 | 1.5 | 1.5 | 1.5 | 1.5 |
| D-1 | [% by wt.] | | 0.5 | 0.5 | 0.5 | 0.5 | 0.5 | 0.5 | 0.5 | 0.5 |
| F-1 | [% by wt.] | | 1.0 | 1.0 | 1.0 | 1.0 | 1.0 | 1.0 | 1.0 | 1.0 |
| TMC content | [% by wt.] | | 0 | 10 | 20 | 30 | 40 | 50 | 60 | 66 |
| Talc/TMC | | | 0 | 3.00 | 1.50 | 1.00 | 0.75 | 0.60 | 0.50 | 0.45 |
| CTI | V | | 275 | 275 | 275 | 275 | 275 | 250 | 300 | 300 |
| UL94V | 1.5 | mm | f./f. | f./f. | f./f. | f./f. | f./f. | f./f. | f./f. | f./f. |
| | 2 d/7 d | | | | | | | | | |
| FOT | s | | 160/181 | 213/178 | 199/208 | 211/199 | 195/208 | 208/180 | 180/180 | 184/197 |
| UL94V | 2 | mm | f./f. | f./V1 | V1/V1 | f./f. | f./f. | f./f. | f./f. | f./f. |

| | | | | | | | | | |
|---|---|---|---|---|---|---|---|---|---|
| | 2 d/7 d | | | | | | | | |
| FOT | s | 67/40 | 87/70 | 103/65 | 167/70 | 185/164 | 197/259 | 183/242 | 204/155 |
| TC, in-plane | W/(mK) | 1.1 | 1.0 | 1.1 | 1.1 | 1.0 | 0.9 | 1.0 | 0.8 |
| Vicat | ° C. | 146 | 154 | 162 | 170 | 179 | 188 | 196 | 203 |

TMC content: Proportion of monomer units of formula (1a′)

Table 2 comprises compositions having 30% by weight of talc and 6-7% by weight of phosphazene and shows the influence of different contents of bisphenol TMC on the Vicat temperature, the flame retardancy properties and the CTI. “FR corr.” is the corrected flame retardant content (component C) of the composition. This is the quotient of the amount of phosphazene and the amount of aromatic polycarbonate, multiplied by 100. As already shown in Table 1, the bisphenol TMC content without additional flame retardant has an insignificantly positive effect on the CTI, but as the value increases it results in an increase in the Vicat softening temperature, which is essential for a balanced profile of properties. With addition of flame retardants, a somewhat more significant positive influence of the TMC content on the CTI can surprisingly be seen. For example, a composition without TMC (V-9) only has a CTI of 275 V, which can be increased to 325 to 350 V (V-10, V-11) with 10-20% by weight of bisphenol TMC, based on the aromatic polycarbonate, and to 400 V (E-12, E-13) with 40-50% by weight of bisphenol TMC.

As expected, the Vicat heat distortion resistance increases with increasing bisphenol TMC content, with the afterflame times increasing and the flame retardancy decreasing.

TABLE 2

| | | | V-9 | V-10 | V-11 | E-12 | E-13 |
|---|---|---|---|---|---|---|---|
| A-1 | [% by wt.] | | 61.0 | 14.0 | 41.8 | 23.6 | 14.5 |
| A-2 | [% by wt.] | | | | 18.2 | 36.4 | 45.5 |
| A-3 | [% by wt.] | | | 46.0 | | | |
| B-1 | [% by wt.] | | 30.0 | 30.0 | 30.0 | 30.0 | 30.0 |
| E-1 | [% by wt.] | | 1.5 | 1.5 | 1.5 | 1.5 | 1.5 |
| D-1 | [% by wt.] | | 0.5 | 0.5 | 0.5 | 0.5 | 0.5 |
| F-1 | [% by wt.] | | 1.0 | 1.0 | 1.0 | 1.0 | 1.0 |
| C-1 | [% by wt.] | | 6.0 | 7.0 | 7.0 | 7.0 | 7.0 |
| TMC content | [% by wt.] | | 0 | 10 | 20 | 40 | 50 |
| FR corr. | [% by wt.] | | 9.8 | 11.7 | 11.7 | 11.7 | 11.7 |
| Filler/TMC | | | 0.00 | 3.00 | 1.50 | 0.75 | 0.60 |
| Filler/FR | | | 0 | 0.26 | 0.13 | 0.09 | 0.05 |
| corr./TMC | | | | | | | |
| CTI | V | | 275 | 325 | 350 | 400 | 400 |
| UL94V | 1.5 | mm | V0/V0 | V0/V0 | V0/V0 | V0/V0 | V0/V0 |
| | 2 d/7 d | | | | | | |
| FOT | s | | 29/19 | 15/22 | 15/24 | 41/22 | 36/36 |
| UL94V | 2 | mm | V0/V0 | V0/V0 | V0/V0 | V0/V0 | V0/V0 |

| | | | | | | |
|---|---|---|---|---|---|---|
| | 2 d/7 d | | | | | |
| FOT | s | 10/10 | 13/20 | 10/22 | 27/11 | 17/29 |
| TC, in-plane | W/(mK) | 1.1 | 1.0 | 0.9 | 1.1 | 0.9 |
| Vicat | ° C. | 129 | 126 | 131 | 143 | 151 |

Table 3 comprises compositions having 30% by weight of talc and 40% by weight, based on the aromatic polycarbonate, of bisphenol TMC monomer units and different contents of phosphazene in order to show the influence of flame retardant on the fire behavior and the CTI and the Vicat temperature. As the examples (V-9 to V-21 from Table 3) show, there is an interrelationship between the amount of flame retardant and the amount of talc and the TMC content, with the result that the required flame retardancy class V-0 in at least 2 mm can only be achieved within certain limits, where the Vicat temperature of the target composition should be as high as possible. The Vicat softening temperature continuously decreases with increasing phosphazene content and in the case of an optimal composition, in relation to flame retardancy and CTI, reaches a value of 132° C. (E-18). If this composition is compared with (V-9), the advantageous use of TMC in combination with phosphazene becomes clear both in terms of Vicat temperature and CTI. The thermal conductivity of all compositions is in the desired range of 0.9-1.1 W/(m*K).

In contrast to talc-filled compositions, the use of high amounts of glass fibers (V-20) or quartz (V-21), likewise in combination with phosphazene, does not have a positive influence on the CTI and also does not provide any significantly improved thermal conductivity with respect to unfilled polycarbonate.

TABLE 3

| | | | V-9 | V-14 | V-15 | E-16 | E-17 | E-18 | E-19 | V-20 | V-21 |
|---|---|---|---|---|---|---|---|---|---|---|---|
| A-1 | [% by wt.] | | 61.0 | 25.0 | 24.4 | 23.6 | 23.2 | 22.4 | 21.7 | 23.8 | 23.8 |
| A-2 | [% by wt.] | | | 39.0 | 37.6 | 36.4 | 35.8 | 34.6 | 33.3 | 37.2 | 37.2 |
| B-1 | [% by wt.] | | 30.0 | 30.0 | 30.0 | 30.0 | 30.0 | 30.0 | 30.0 | | |
| B*-2 | [% by wt.] | | | | | | | | | 30.0 | |
| B*-3 | [% by wt.] | | | | | | | | | | 30.0 |
| E-1 | [% by wt.] | | 1.5 | 1.5 | 1.5 | 1.5 | 1.5 | 1.5 | 1.5 | 1.5 | 1.5 |
| D-1 | [% by wt.] | | 0.5 | 0.5 | 0.5 | 0.5 | 0.5 | 0.5 | 0.5 | 0.5 | 0.5 |
| F-1 | [% by wt.] | | 1.0 | 1.0 | 1.0 | 1.0 | 1.0 | 1.0 | 1.0 | 1.0 | 1.0 |
| C-1 | [% by wt.] | | 6.0 | 3.0 | 5.0 | 7.0 | 8.0 | 10.0 | 12.0 | 6.0 | 6.0 |
| TMC content | [% by wt.] | | 0 | 40 | 40 | 40 | 40 | 40 | 40 | 40 | 40 |
| FR corr. | [% by wt.] | | 9.8 | 4.7 | 8.1 | 11.7 | 13.6 | 17.5 | 21.8 | 9.8 | 9.8 |
| Filler/TMC | | | 0 | 0.75 | 0.75 | 0.75 | 0.75 | 0.75 | 0.75 | 0.75 | 0.75 |
| Filler/FR corr./TMC | | | 0 | 0.16 | 0.09 | 0.06 | 0.06 | 0.05 | 0.04 | 0.03 | 0.08 |
| CTI | V | | 275 | 325 | 325 | 400 | 500 | 575 | 400 | 225 | 200 |
| UL94V | 1.5 | mm | V0/V0 | f./f. | V1/V1 | V0/V0 | V0/V0 | V0/V0 | V0/V0 | V1/V1 | V1/V1 |
| | 2 d/7 d | | | | | | | | | | |
| FOT | s | | 29/19 | 180/194 | 89/67 | 41/22 | 39/14 | 24/13 | 24/14 | 87/77 | 75/49 |
| UL94V | 2 | mm | V0/V0 | f./f. | V1/V1 | V0/V0 | V0/V0 | V0/V0 | V0/V0 | V0/V0 | V0/V0 |

| | | | | | | | | | | |
|---|---|---|---|---|---|---|---|---|---|---|
| | 2 d/7 d | | | | | | | | | |
| FOT | s | 10/10 | 156/159 | 70/44 | 27/11 | 24/14 | 13/7 | 22/8 | 41/47 | 18/27 |
| TC, in-plane | W/(mK) | 1.1 | 0.9 | 1.1 | 1.1 | 1.0 | 1.0 | 0.9 | 0.3 | 0.3 |
| Vicat | ° C. | 129 | 167 | 152 | 143 | 140 | 132 | 124 | 151 | 158 |

Compositions composed of polycarbonate having 35% by weight and 40% by weight of talc with different TMC contents are compiled in Table 4. It can also be seen here that talc content, TMC concentration and amount of flame retardant are interrelated and it is only within certain limits that both a high CTI and good flame retardancy can be achieved. A slight increase in the concentration of the MAH-modified polymer also results in a further increase in the CTI (E-24 and E-25). 5

The higher the talc content, the lower the flame retardancy, which is apparent from the high afterflame times. This phenomenon can only be compensated for by higher amounts of flame retardants (afterflame times decrease). However, since the Vicat softening temperature decreases with increasing content of flame retardant, the bisphenol TMC content of the composition should be changed in order to maintain a still sufficiently high Vicat softening temperature of at least 120° C. (V-28 and V-32).

TABLE 4

| | | | E-22 | E-23 | E-24 | E-25 | E-26 | V-27 | V-28 | E-29 | E-30 | V-31 | V-32 | E-33 | E-34 |
|---|---|---|---|---|---|---|---|---|---|---|---|---|---|---|---|
| A-1 | [% by wt.] | | 30.0 | 28.1 | 21.9 | 21.7 | 20.5 | 19.5 | 18.3 | 18.3 | 18.3 | 12.1 | 11.3 | 11.3 | 11.3 |
| A-2 | [% by wt.] | | 25.0 | 23.4 | 34.1 | 33.8 | 31.5 | 30.0 | 28.2 | 26.2 | 24.2 | 37.9 | 35.2 | 31.2 | 33.2 |
| B-1 | [% by wt.] | | 35.0 | 35.0 | 35.0 | 35.0 | 35.0 | 40.0 | 40.0 | 400 | 40.0 | 40.0 | 30.0 | 40.0 | 40.0 |
| E-1 | [% by wt.] | | 1.5 | 2.0 | 1.5 | 2.0 | 1.5 | 2.0 | 2.0 | 2.0 | 2.0 | 1.5 | 2.0 | 2.0 | 2.0 |
| D-1 | [% by wt.] | | 0.5 | 0.5 | 0.5 | 0.5 | 0.5 | 0.5 | 0.5 | 0.5 | 0.5 | 0.5 | 0.5 | 0.5 | 0.5 |
| F-1 | [% by wt.] | | 1.0 | 1.0 | 10 | 1.0 | 1.0 | 1.0 | 1.0 | 1.0 | 1.0 | 1.0 | 1.0 | 1.0 | 1.0 |
| C-1 | [% by wt.] | | 7.0 | 10.0 | 6.0 | 6.0 | 10.0 | 7.0 | 10.0 | 12.0 | 14.0 | 7.0 | 10.0 | 12.0 | 14.0 |
| TMC | [% by wt.] | | 30 | 30 | 40 | 40 | 40 | 40 | 40 | 40 | 40 | 50 | 50 | 50 | 50 |
| content | | | | | | | | | | | | | | | |
| FR corr. | [% by wt.] | | 12.7 | 19.4 | 10.7 | 10.8 | 19.2 | 14.1 | 21.5 | 27.0 | 32.9 | 14.0 | 21.5 | 28.2 | 31.5 |
| Filler/TMC | | | 1.17 | 1.17 | 0.88 | 0.88 | 0.88 | 1.00 | 1.00 | 1.00 | 1.00 | 0.80 | 0.80 | 0.80 | 0.80 |
| Filler/FR | | | 0.09 | 0.06 | 0.08 | 0.08 | 0.05 | 0.07 | 0.05 | 0.04 | 0.03 | 0.06 | 0.04 | 0.03 | 0.03 |
| corr./TMC | | | | | | | | | | | | | | | |
| CTI | V | | 425 | 600 | 400 | 525 | 575 | 575 | 575 | 600 | 600 | 550 | 600 | 600 | 575 |
| UL94V | 1.5 | mm | V0/V0 | V0/V0 | V0/V0 | V0/V0 | V0/V0 | f./f. | f./f. | f./f. | f./f. | f./f. | f./f. | f./f. | V1/V0 |
| | 2 d/7 d | | | | | | | | | | | | | | |
| FOT | s | | 28/35 | 22/17 | 68/40 | 26/21 | 19/17 | 194/219 | 117/178 | 179/173 | 93/27 | 173/170 | 162/120 | 143/121 | 95/38 |
| UL94V | 2 | mm | V0/V0 | V0/V0 | V0/V0 | V0/V0 | V0/V0 | f./f. | f./V0 | V0/V0 | V0/V0 | f./V0 | f./f. | V0/V0 | V0/V0 |

| | | | | | | | | | | | | | | |
|---|---|---|---|---|---|---|---|---|---|---|---|---|---|---|
| | 2 d/7 d | | | | | | | | | | | | | |
| FOT | s | 21/15 | 13/11 | 20/22 | 19/23 | 13/12 | 181/148 | 112/19 | 31/24 | 33/29 | 168/29 | 94/52 | 30/13 | 15/23 |
| TC, in- | W/(mK) | 1.2 | 1.3 | 1.1 | 1.2 | 1.2 | 1.4 | 1.3 | 1.8 | 1.7 | 1.4 | 3.3 | 1.9 | 1.6 |
| plane | | | | | | | | | | | | | | |
| Vicat | ° C. | 136 | 125 | 153 | 146 | 131 | 139 | 126 | 118 | 109 | 146 | 135 | 121 | 112 |

1. A thermoplastic composition, containing
A) at least 44.5% by weight of aromatic polycarbonate, wherein the aromatic polycarbonate contains
one or more monomer units of formula (1a) 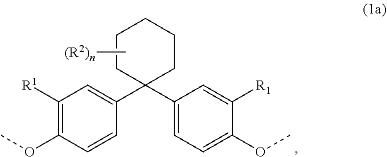
in which
R¹ is hydrogen or a C₁—to C₄-alkyl radical,
R² is a C₁—to C₄-alkyl radical,
n is 0, 1, 2 or 3,
in a proportion of 30% to 65% by weight, based on the total weight of the aromatic polycarbonate,
B) 30% to 40% by weight of talc,
C) 6% to 14% by weight of phosphorus-containing flame retardant, wherein the quotient of the amount of component C, based on the overall composition, and
the amount of component A, based on the overall composition, multiplied by 100, is >10.0,
D) 0.3% to 2.0% by weight of fluorine-containing anti-drip agent,
E) 1% to 3% by weight of anhydride-modified α-olefin polymer,
wherein, if the talc content is <35.0% by weight, the proportion of monomer units of formula (1a), based on the total weight of the aromatic polycarbonate, is at least 35% by weight and wherein, if the talc content is >37% by weight, phosphazene is present as phosphorus-containing flame retardant and the phosphazene content is >10.0% by weight, based on the overall composition.

2. The thermoplastic composition as claimed in claim 1, wherein the proportion of monomer units of formula (1a), based on the total weight of the aromatic polycarbonate, is 40% to 60% by weight.

3. The thermoplastic composition as claimed in claim 1, wherein the talc content of the thermoplastic composition is 30% to 35% by weight.

4. The thermoplastic composition as claimed in claim 1, wherein the amount of fluorine-containing anti-drip agent is 0.4% to 1.0% by weight.

5. The thermoplastic composition as claimed in claim 1, wherein the phosphorus-containing flame retardant is a phosphazene or a mixture of different phosphazenes.

6. The thermoplastic composition as claimed in claim 1, wherein the anhydride-modified α-olefin polymer comprises maleic anhydride-modified propylene polymer.

7. The thermoplastic composition as claimed in claim 1, wherein the composition contains 0.2% to 2.0% by weight of titanium dioxide.

8. The thermoplastic composition as claimed in claim 1, wherein, if the talc content is <35% by weight, the proportion of monomer units of formula (1a), based on the total weight of the aromatic polycarbonate, is at least 40% by weight.

9. The thermoplastic composition as claimed in claim 1, wherein the quotient of the amount of component C, based on the overall composition, and the amount of component A, based on the overall composition, multiplied by 100, is ≥10.7.

10. The thermoplastic composition as claimed in claim 1, containing
A) at least 50% by weight of aromatic polycarbonate, wherein the proportion of monomer units of formula (1a), based on the total weight of the aromatic polycarbonate, is 30-60% by weight,
B) 30% to 35% by weight of talc,
C) 6% to 12% by weight of phosphorus-containing flame retardant, wherein the quotient of the amount of component C, based on the overall composition, and
the amount of component A, based on the overall composition, multiplied by 100, is >10.0,
D) 0.3% to 2.0% by weight of fluorine-containing anti-drip agent,
E) 1% to 3% by weight of anhydride-modified α-olefin polymer,
wherein, if the talc content is <35.0% by weight, the proportion of monomer units of formula (1a), based on the total weight of the aromatic polycarbonate, is at least 35% by weight.

11. The thermoplastic composition as claimed claim 1, consisting of
A) at least 44.5% by weight of aromatic polycarbonate, wherein the proportion of monomer units of formula (1a), based on the total weight of the aromatic polycarbonate, is 30-65% by weight,
B) 30% to 40% by weight of talc,
C) 6% to 14% by weight of phosphorus-containing flame retardant, wherein the quotient of
the amount of component C, based on the overall composition, and
the amount of component A, based on the overall composition,
multiplied by 100,
is >10.0,
D) 0.3% to 2.0% by weight of fluorine-containing anti-drip agent,
E) 1% to 3% by weight of anhydride-modified α-olefin polymer,
F) optionally one or more further additive(s), selected from the group consisting of heat stabilizers, antioxidants, mold-release agents, UV absorbers, IR absorbers, impact modifiers, antistats, flame retardants different from component C, optical brighteners, light-scattering agents, hydrolysis stabilizers, transesterification stabilizers, organic dyes, organic or inorganic pigments, compatibilizers, additives for laser marking,
wherein, if the talc content is <35.0% by weight, the proportion of monomer units of formula (1a), based on the total weight of the aromatic polycarbonate, is at least 35% by weight and wherein, if the talc content is >37% by weight, phosphazene is present as phosphorus-containing flame retardant and the phosphazene content is >10.0% by weight, based on the overall composition.

12. A molding consisting of, or comprising a region made from, a thermoplastic composition as claimed in claim 1.

13. The molding as claimed in claim 12, wherein the molding is part of a high-voltage switch, inverter, relay, electronic connector, electrical connector, circuit breaker, a photovoltaic system, an electric motor, a heat sink, a charger or charging plug for electric vehicles, an electrical junction box, a smart meter housing, a miniature circuit breaker, or a busbar.

14. An EE component, comprising
a first electrical conductor and a second electrical conductor at a first distance d1 and a second distance d2 with respect to one another,
which are connected via a thermoplastic composition as claimed in claim 1, which is in direct contact with the first electrical conductor and the second electrical conductor,
wherein the distance d1 is the shortest distance between the first electrical conductor and the second electrical conductor along the surface of the thermoplastic composition and
wherein the distance d2 is the shortest distance between the first electrical conductor and the second electrical conductor through the air,
wherein d2 is selected in such a way that at the respective operating voltage a sparkover through the air is prevented and
wherein d1, at the operating voltage U listed below, is:
$$\begin{matrix}d 1 i ( 0 V \leq U \leq 250 V ) : 1.8 mm to < 2.5 mm \\ d 1 ii ( 250 V < U \leq 500 V ) = 3.6 mm to < 5. mm \\ d 1 iii ( 500 V < U \leq 1000 V ) = 7.1 mm to < 10. mm .\end{matrix}$$

15. The EE component as claimed in claim 14, wherein the EE component has an IP6K9K degree of protection according to ISO 20653:2013-02.
